(19) United States
(12) Patent Application Publication
(10) Pub. No.: US 2023/0086413 A1
(43) Pub. Date: Mar. 23, 2023

(54) PHOTORADICAL POLYMERIZABLE COMPOSITION

(71) Applicant: AIR WATER PERFORMANCE CHEMICAL INC., Kawasaki-shi (JP)

(72) Inventors: Shunichi HIMORI, Kawasaki-shi (JP); Yuko OGATA, Kawasaki-shi (JP); Keita IUCHI, Kawasaki-shi (JP); Toshihiko MIYATA, Kawasaki-shi (JP)

(73) Assignee: AIR WATER PERFORMANCE CHEMICAL INC., Kawasaki-shi (JP)

(21) Appl. No.: 17/904,973

(22) PCT Filed: Feb. 24, 2021
(86) PCT No.: PCT/JP2021/006813

§ 371 Date: Aug. 25, 2022

(30) Foreign Application Priority Data
Feb. 27, 2020 (JP) 2020-032236
Sep. 19, 2020 (JP) 2020-157977
Oct. 3, 2020 (JP) 2020-168135
Jan. 22, 2021 (JP) 2021-008829

(51) Int. Cl. C08F 2/50; C08F 4/32; C08F 20/10

(52) U.S. Cl. CPC C08F 2/50; C08F 4/32; C08F 20/10

(57) ABSTRACT

A photoradical polymerization initiator that is environmentally friendly and composed solely of carbon, hydrogen and oxygen atoms, generating no acid that may cause corrosion during a radical polymerization reaction, and having a high radical polymerization initiation capacity to light having a wavelength of 350 nm to 420 nm. A photoradical polymerizable composition including a radical polymerizable compound and a photoradical polymerization initiator, where the photoradical polymerization initiator is a 1,4-dihydroxy-2-naphthoic acid compound represented by formula (1):

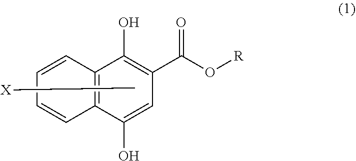

where R is a hydrogen atom, a C₁₋₁₀ alkyl group or a C₆₋₁₄ aryl group, and X is a hydrogen atom, a C₁₋₁₀ alkyl group, a C₆₋₁₄ aryl group, a hydroxy group, a C₁₋₁₀ alkoxy group or a C₆₋₁₄ aryloxy group.

### TECHNICAL FIELD

The present invention relates to a photoradical polymerizable composition, particularly a photoradical polymerizable composition containing a 1,4-dihydroxy-2-naphthoic acid compound as a photoradical polymerization initiator.

### BACKGROUND ART

An energy ray-cured resin is obtained by irradiating energy ray-polymerizable composition with energy rays such as ultraviolet rays or electron beams to be polymerized and cured. The technology of curing by energy rays has been used for various applications, for example, for a coating material for woodworking, a coating material for e.g. metals, an ink for screen printing and offset printing, a dry film resist to be used for printed circuit boards, and a hologram material, a sealing agent, an overcoating material, a resin for stereolithography, an adhesive, etc.

The energy ray-polymerizable composition is mainly composed of a polymerizable compound and a polymerization initiator which initiates polymerization of the polymerizable compound by irradiation with energy. The polymerization method may be radical polymerization, cationic polymerization or anionic polymerization, and among them, radical polymerization has been most widely used for a long time. Radical polymerization is classified into heat radical polymerization and photoradical polymerization, and in photoradical polymerization, usually, a photoradical polymerization initiator is used together with a radical polymerizable compound, and by irradiation with energy rays, mainly ultraviolet rays, radicals are generated from the photoradical polymerization initiator thereby to initiate polymerization of the radical polymerizable compound.

The photoradical polymerization initiator is classified into an intramolecular cleavage type and a hydrogen withdrawal type. In the photoradical polymerization initiator of the intramolecular cleavage type, by absorbing light having a specific wavelength, a bond at a specific moiety is cleft, radicals are generated at the cleft moiety, which function as polymerization initiation species to initiate polymerization of the radical polymerizable compound. On the other hand, in the case of hydrogen withdrawal type, the photoradical polymerization initiator absorbs light having a specific wavelength and becomes in an excited state, the excited species bring about hydrogen withdrawal reaction from a surrounding hydrogen donor and thereby generate radicals, which function as polymerization initiator species to initiate polymerization of the radical polymerizable compound.

As the intramolecular cleavage type photoradical polymerization initiator, an alkylphenone type photoradical polymerization initiator, an aminoalkylphenone type photoradical polymerization initiator, an acylphosphine oxide type photoradical polymerization initiator, an oxime ester type photoradical polymerization initiator, etc. have been known. As the alkylphenone type photoradical polymerization initiator, a benzyl methyl ketal type photoradical polymerization initiator, an α-hydroxyalkylphenone type photoradical polymerization initiator, etc. may be mentioned, and as specific compounds, for example, the benzyl methyl ketal type photoradical polymerization initiator may, for example, be 2,2′-dimethoxy-1,2-diphenylethan-1-one (trade name: OMNIRAD 651, OMNIRAD is a registered trademark of IGM Group B.V.). The α-hydroxyalkylphenone type photoradical polymerization initiator may, for example, be 2-hydroxy-2-methyl-1-phenylpropan-1-one (trade name: OMNIRAD 1173), 1-hydroxycyclohexyl phenyl ketone (trade name: OMNIRAD 184), 1-[4-(2-hydroxyethoxy)phenyl]-2-hydroxy-2-methyl-1-propan-1-one (trade name: OMNIRAD 2959), or 2-hydroxy-1-{4-[4-(2-hydroxy-2-methylpropionyl)benzyl]phenyl}-2-methylpropan-1-one (trade name: OMNIRAD 127). The aminoalkylphenone type photoradical polymerization initiator may, for example, be 2-methyl-1-(4-methylthiophenyl)-2-morpholinopropan-1-one (trade name: OMNIRAD 907) or 2-benzylmethyl 2-dimethylamino-1-(4-morpholinophenyl)-1-butanone (trade name: OMNIRAD 369). The acylphosphine oxide type photoradical polymerization initiator may, for example, be 2,4,6-trimethylbenzoyl-diphenylphosphine oxide (trade name: OMNIRAD TPO) or bis(2,4,6-trimethylbenzoyl)-phenylphosphine oxide (trade name: OMNIRAD 819). The oxime ester type photoradical polymerization initiator may, for example, be (2E)-2-(benzoyloxyimino)-1-[4-(phenylthio)phenyl]octan-1-one (trade name: Irgacure OXE-01, Irgacure is a registered trademark of BASF Societas Europaea) (Patent Document 1).

On the other hand, as the hydrogen withdrawal type radical polymerization initiator, a benzophenone type photoradical polymerization initiator, a thioxanthone type photoradical polymerization initiator, etc. have been known (Patent Document 7). The benzophenone type photoradical polymerization initiator may, for example, be methyl o-benzoylbenzoate, benzophenone, 4-phenylbenzophenone, or a commercial product OMNIRAD 4PBZ (OMNIRAD is a registered trademark of IGM Group B.V.), OMNIRAD OMBB, etc. The thioxanthone type photoradical polymerization initiator may, for example, be 2,4-diethylthioxanthone or 2-isopropylthioxanthone.

Among these photoradical polymerization initiators, the alkylphenone type photoradical polymerization initiator contains no atom having high activity on the body and thus of concern about the safety, such as a nitrogen atom or a phosphorus atom, and is thereby an environmentally friendly photoradical polymerization initiator composed solely of oxygen atoms, carbon atoms and hydrogen atoms. For such a photoradical polymerization initiator, as an energy ray irradiation source, a high pressure mercury lamp (having a light emission spectrum also in a wavelength range shorter than 350 nm) has been mainly used. However, a metal halide lamp and a gallium-doped lamp emitting light having a longer wavelength have been used recently, and the alkylphenone type photoradical polymerization initiator has no sufficient initiation capacity in the wavelength region by a high pressure mercury lamp, and thus aminoalkylphenone type and acylphosphine oxide type, and further oxime ester type photoradical polymerization initiators have been developed.

The benzophenone type photoradical polymerization initiator also contains no atom having high activity on the body and thus of concern about the safety, such as a nitrogen atom or a phosphorus atom, and is thereby an environmentally friendly photoradical polymerization initiator composed solely of oxygen atoms, carbon atoms and hydrogen atoms. Although the benzophenone type photoradical polymerization initiator has low radical generation efficiency when used alone, it can provide a cured product with a high surface hardness when used in combination with a hydrogen donor or an intramolecular cleavage type initiator, and thus a cured product containing such an initiator is characterized by having e.g. high adhesion to a plastic substrate (Patent Document 8). However, the light absorption range of the benzophenone type photoradical polymerization initiator is at a level of 350 nm at most, and when polymerization and curing are to be conducted by light having a wavelength longer than 350 nm, the polymerization will not proceed or will proceed but insufficiently, and thus the benzophenone type photoradical polymerization initiator is unsuitable for curing by long wavelength light in the same manner as the alkylphenone type photoradical polymerization initiator.

In recent year, for polymerization reaction employing ultraviolet rays as energy rays, LED (light emitting diode) has been used as an irradiation source. LED is characterized in that as different from a high pressure mercury lamp, it generates less heat and has long life, and thus development of ultraviolet curing technique employing LED is accelerating. As typical LED, ultraviolet LED and blue LED have been known. Particularly, development of ultraviolet LED is in progress as a UV curing irradiation source for ink jet printing or for semiconductor-related resist. As the ultraviolet LED, LEDs with center wavelengths of 405 nm, 395 nm, 385 nm, 375 nm and 365 nm have been developed. As photoradical polymerization initiators adapted to such wavelengths, among the above-mentioned photoradical polymerization initiators, 2-methyl-1-(4-methylthiophenyl)-2-morpholinopropan-1-one (trade name: OMNIRAD 907), 2-benzylmethyl 2-dimethylamino-1-(4-morpholinophenyl)-butanone-1 (trade name: OMNIRAD 369), 2,4,6-trimethylbenzoyl-diphenylphosphine oxide (trade name: OMNIRAD TPO), bis(2,4,6-trimethylbenzoyl)-phenylphosphine oxide (trade name: OMNIRAD 819), etc. are known to have high sensitivity (Patent Document 2).

However, such photoradical polymerization initiators contain a nitrogen atom, a sulfur atom or a phosphorus atom as an atom constituting the molecular structure, and thus many of them have high activity on the body and are of concern about the safety. Further, a photoradical polymerization initiator containing a nitrogen atom or a sulfur atom may cause a problem of an odor during operation or from a cured product. Further, yellowing with time is also pointed out.

At present, a photoradical polymerization initiator which can initiate radical polymerization with e.g. LED which emits light within a range of from 350 nm to 420 nm is limited to acylphosphine oxide type photoradical polymerization initiators, some of oxime ester type photoradical polymerization initiators and thioxanthone type photoradical polymerization initiators, etc., and they are all compounds containing a nitrogen atom, a sulfur atom or a phosphorus atom. Photoradical polymerization initiators, which are compounds composed solely of carbon atoms, hydrogen atoms and oxygen atoms, and which are active within the above wavelength range, are scarcely known. That is, in order to achieve high activity to energy rays including light having a wavelength within a range of from 350 nm to 400 nm, a nitrogen atom, a sulfur atom or a phosphorus atom has to be contained in practice. Accordingly, environmentally friendly photoradical polymerization initiators composed solely of carbon atoms, hydrogen atoms and oxygen atoms, and having high activity to energy rays including light having a wavelength within a range of from 350 nm to 420 nm, have been desired.

Further, acylphosphine oxide type photoradical polymerization initiators and some of oxime ester type photoradical polymerization initiators are known to have photobleaching property. Photobleaching means photofading and is a photochemical property rarely seen in excited fluorescent molecules. This reaction indicates such a reaction that a fluorescent substance in an excited state is chemically activated and becomes unstable as compared with in a ground state, and the fluorescent molecules in an excited state are decomposed and finally converted to have a low fluorescent structure. Among the photopolymerization initiators, acylphosphine oxide type photoradical polymerization initiators and some of oxime ester type photoradical polymerization initiators have such photobleaching property. Such initiators are known as follows. In a function as a polymerization initiator by absorbing light in a certain ultraviolet region and generating radicals, if the conjugated bond of the molecules after generating radicals is cleaved, the initiator no more absorbs light in the ultraviolet region. As a result, the resulting cured product is hardly colored, and curing will smoothly proceed even in the case of a thick film as light in the ultraviolet region can be transmitted into the interior. Particularly 2,4,6-trimethylbenzoyl-diphenylphosphine oxide (trade name: OMNIRAD TPO) which is one of acylphosphine oxide type photoradical polymerization initiators is well known (Patent Document 9, Non-Patent Document 3). However, a practical compound as an environmentally friendly photoradical polymerization initiator composed solely of carbon atoms, hydrogen atoms and oxygen atoms, which has such photobleaching property, has not been known yet.

The present applicants have already found that 1,4-bis(substituted oxy)-2-naphthoic acid compounds and 1-hydroxy-2-naphthoic acid compounds having a substituted oxy group at the 4-position function as a photopolymerization sensitizer in photocationic polymerization and photoradical polymerization employing an onium salt as a photopolymerization initiator. The present applicants disclose that 1,4-dihydroxy-2-naphthoic acid also functions as a photopolymerization sensitizer, as an example of 1-hydroxy-2-naphthoic acid compounds having a substituted oxy group at the 4-position (Patent Document 3, 4). They further disclose in the documents that 1,4-dihydroxy-2-naphthoic acid is quickly excited upon irradiation with energy rays including light having a wavelength within a range of from 300 nm to 420 nm, the excitation energy is propagated to an onium salt as a photocationic polymerization initiator to activate the onium salt thereby to polymerize a photocationic polymerizable compound and a radical polymerizable compound. That is, it is disclosed that in combination with an onium salt, 1,4-bis(substituted oxy)-2-naphthoic acid compounds and 1-hydroxy-2-naphthoic acid compounds having a substituted oxy group at the 4-position, function as a sensitizer to the onium salt.

However, although they disclose function of the 1-hydroxy-2-naphthoic acid compounds having a substituted oxy group at the 4-position as a sensitizer, they fail to disclose function of the 1,4-dihydroxy-2-naphthoic acid compound as a photoradical polymerization initiator, and they fail to disclose specific functions and effects of 1,4-dihydroxy-2-naphthoic acid compound in which the substituent at the 4-position is a hydroxy group, such that it function as a radical polymerization inhibitor in dark place, which is not seen in other 1-hydroxy-2-naphthoic acid compounds having a substituted oxy group at the 4-position. They disclose the 1-hydroxy-2-naphthoic acid compound having a substituted oxy group at the 4-position merely in a list of photopolymerization sensitizers.

Further, Patent Document 3 disclose in paragraph [0060] in (Photopolymerization initiator) that “the photopolymerization initiator is preferably an onium salt. The onium salt may be”, that is, as a photopolymerization initiator, only onium salts are exemplified, and photoradical polymerization initiators other than onium salts are not disclosed. An onium salt is commonly used as an initiator for photocationic polymerization but has a capacity also as a photoradical polymerization initiator. Thus, Patent Document 3 discloses that the 1-hydroxy-2-naphthoic acid compound having a substituted oxy group at the 4-position has a sensitizing effect on onium salts which function as a polymerization initiator both in photocationic polymerization and photoradical polymerization. However, onium salts as the photoradical polymerization initiator and other photoradical polymerization initiators are different in the mechanism of generation of radical polymerization initiation species. That is, when an onium salt is used as a radical polymerization initiator, not only radical species but also a strong acid as cation species is generated, and the resulting acid may cause problem of corrosion. This problem is serious in electronic material applications.

For example, Patent Document 5 discloses that corrosion may occur when an onium salt type initiator is used, as in paragraph [0003] disclosing Background Art regarding “onium borate type acid generator” stating that “Incidentally, the cationic polymerization initiator (acid generator) described in these specifications contains BF⁴⁻, PF⁶⁻, AsF⁶⁻ and SbF⁶⁻ as anions.”, “In addition, since HF is produced as a by-product by decomposition of an initiator (acid generator) in common with these anions, there is a problem that a substrate, equipment, or the like is liable to be corroded. In particular, in electronic materials and semiconductor materials, it is an important problem in electrical characteristics (insulation reliability). In such applications, cationic polymerization initiators (acid generators) which provide a sufficient reliability have been sought.”

Further, Non-Patent Document 1 discloses that “a photoinitiation cationic polymerization is capable of polymerization without inhibition by oxygen, and is interesting in that ring-opening polymerization of a vinyl ether or a cyclic compound is possible, however, practically, depending upon applications, corrosion of metals by formed acids may be a significant problem”. Further, Non-Patent Document 2 discloses that “an onium salt used as a potent initiator may remain as ionic impurities in the cured coating film and may deteriorate electrical characteristics and moisture resistance and corrode metals”. Every document discloses that an onium salt used as a photopolymerization initiator generates acid components by light irradiation and will impair electrical materials, etc.

On the other hand, as an example of an anthracene derivative compound and a naphthalene derivative compound used in combination with an anthracene derivative compound as a light sensitizer to a photosensitive acid generator for photocationic polymerizable compositions, a compound having a carboalkoxy group at the 2-position of the naphthalene ring is disclosed (Patent Document 6), however, Patent Document 6 only discloses that the compound having a carboalkoxy group at the 2-position of the naphthalene ring functions as a sensitizer to an onium salt as a photosensitive acid generator, and it discloses the compound having a carboalkoxy group at the 2-position of the naphthalene ring merely in a list of other naphthalene compounds having a hydrogen atom, an alkyl group or the like as a substituent at the 2-position of the naphthalene ring, and it fails to disclose specificity of the naphthalene ring having a carboalkoxy group at the 2-position.

### PRIOR ART DOCUMENTS

### Patent Documents

Patent Document 1: JP-A-S63-150303
Patent Document 2: JP-A-2000-016910
Patent Document 3: JP-A-2017-8008
Patent Document 4: JP-A-2017-8269
Patent Document 5: JP-A-2014-205624
Patent Document 6: WO2006/073021
Patent Document 7: JP-A-H07-33809
Patent Document 8: JP-A-2013-23549
Patent Document 9: JP-A-2020-70444

### Non-Patent Documents

Non-Patent Document 1: POLYMERS, vol. 45, November, 1996, page 786, TSUNOOKA Masahiro (Department of Applied Chemistry, Graduate School of Engineering, Osaka Prefecture University), “Latest Trends of Photo-Initiation Technology”
Non-Patent Document 2: TOAGOSEI CO., LTD., annual report TREND 2004 Vol. 7, page 30, SASAKI Hiroshi, “OX-SC: Liquid material capable of forming organic/inorganic hybrid”
Non-Patent Document 3: W. Arthur Green, Industrial Photoinitiators: A Technical Guide, p 30, CRC Press, 2010

### DISCLOSURE OF INVENTION

### Technical Problem

The object of the present invention is to provide a highly practical novel photoradical polymerization initiator sensitive to energy rays including light having a wavelength within a range of from 350 nm to 420 nm and having high radical polymerization initiation capability.

### Solution to Problem

The present inventors have conducted extensive studies on the structure of naphthalene compounds and their photopolymerization properties and as a result, found that the 1,4-dihydroxy-2-naphthoic acid compounds of the present invention, although they have a simple structure composed solely of carbon atoms, hydrogen atoms and oxygen atoms, generate active radical species by irradiation with light having long wavelength of from 350 nm to 420 nm, have specifically high photoradical polymerization initiation capability in photoradical polymerization reaction and are very excellent in capacity of photoradical polymerizing a radical polymerizable compound. They have found the following surprising facts. That is, the 1,4-dihydroxy-2-naphthoic acid compound of the present invention functions as a radical polymerization inhibitor in dark place without irradiation with light to prevent unintended radical polymerization, and when irradiated with light having a wavelength within a range of from 350 nm to 420 nm, it loses radical polymerization inhibiting capacity and at the same time generates radical species to function as a photoradical polymerization initiator, and further, it has photobleaching function such that it absorbs light having a wavelength within a range of from 350 nm to 420 nm to generate radicals thereby to function as a photoradical polymerization initiator but after generating radicals, the conjugated bond of molecules are cleaved and it no more absorbs light in the ultraviolet region. And further, although the 1,4-dihydroxy-2-naphthoic acid compound may be used alone as a photoradical polymerization initiator, when used in combination with other known photoradical polymerization initiator, polymerization is very quickly initiated. The present invention has been accomplished on the basis of these discoveries.

That is, the present invention resides in the following. According to a first aspect, the present invention provides a photoradical polymerizable composition comprising a radical polymerizable compound and a photoradical polymerization initiator, wherein the photoradical polymerization initiator is a 1,4-dihydroxy-2-naphthoic acid compound represented by the following formula (1):

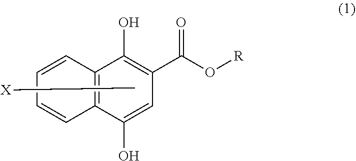

wherein R is a hydrogen atom, a C₁₋₁₀ alkyl group or a C₆₋₁₄ aryl group, and X is a hydrogen atom, a C₁₋₁₀ alkyl group, a C₆₋₁₄ aryl group, a hydroxy group, a C₁₋₁₀ alkoxy group or a C₆₋₁₄ aryloxy group, provided that the alkyl group or aryl group represented as R may further be substituted by an alkoxy group, a hydroxy group or a (meth)acrylic group.

According to a second aspect, the present invention provides a photoradical polymerizable composition comprising a radical polymerizable compound and a photoradical polymerization initiator, wherein the photoradical polymerization initiator contains a 1,4-dihydroxy-2-naphthoic acid compound represented by the following formula (1), and a photoradical polymerization initiator (excluding the 1,4-dihydroxy-2-naphthoic acid compound) other than an onium salt:

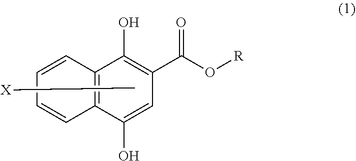

wherein R is hydrogen atom, a C₁₋₁₀ alkyl group or a C₆₋₁₄ aryl group, and X is a hydrogen atom, a C₁₋₁₀ alkyl group, a C₆₋₁₄ aryl group, a hydroxy group, a C₁₋₁₀ alkoxy group or a C₆₋₁₄ aryloxy group, provided that the alkyl group or aryl group represented as R may further be substituted by an alkoxy group, a hydroxy group or a (meth)acrylic group.

According to a third aspect, the present invention provides the photoradical polymerizable composition according to the second aspect, wherein the photoradical polymerization initiator (excluding the 1,4-dihydroxy-2-naphthoic acid compound) other than an onium salt is an alkylphenone type photoradical polymerization initiator, a benzophenone type photoradical polymerization initiator or an anthraquinone type photoradical polymerization initiator.

According to a fourth aspect, the present invention provides the photoradical polymerizable composition according to the second aspect, wherein the photoradical polymerization initiator (excluding the 1,4-dihydroxy-2-naphthoic acid compound) other than an onium salt is an acylphosphine oxide type photoradical polymerization initiator, an oxime ester type photoradical polymerization initiator, an α-aminoacetophenone type photoradical polymerization initiator or a thioxanthone type photoradical polymerization initiator.

According to a fifth aspect, the present invention provides the photoradical polymerizable composition according to the second aspect, wherein the photoradical polymerization initiator (excluding the 1,4-dihydroxy-2-naphthoic acid compound) other than an onium salt is a biimidazole type photoradical polymerization initiator.

According to a sixth aspect, the present invention provides the photoradical polymerizable composition according to any one of the second to fifth aspects, wherein the blend ratio of the 1,4-dihydroxy-2-naphthoic acid compound represented by the formula (1) to the photoradical polymerization initiator (excluding the 1,4-dihydroxy-2-naphthoic acid compound) other than an onium salt is within a range of from 99:1 to 1:99 by the weight ratio.

According to a seventh aspect, the present invention provides the photoradical polymerizable composition according to any one of the first to sixth aspects, wherein the 1,4-dihydroxy-2-naphthoic acid compound represented by the formula (1) is 1,4-dihydroxy-2-naphthoic acid.

According to an eighth aspect, the present invention provides the photoradical polymerizable composition according to any one of the first to sixth aspects, wherein the 1,4-dihydroxy-2-naphthoic acid compound represented by the formula (1) is phenyl 1,4-dihydroxy-2-naphthoate.

According to a ninth aspect, the present invention provides the photoradical polymerizable composition according to any one of the first to eighth aspects, which further contains a polymerizable resin.

According to a tenth aspect, the present invention provides a method for photopolymerizing the photoradical polymerizable composition as defined in any one of the first to ninth aspects, which comprises applying energy rays including light having a wavelength within a range of from 350 nm to 420 nm.

### Advantageous Effects of Invention

The 1,4-dihydroxy-2-naphthoic acid compound of the present invention functions as a photoradical polymerization initiator in photoradical polymerization reaction by irradiation with energy rays including light having a wavelength within a range of from 350 nm to 420 nm and has a capability of very quickly polymerizing a radical polymerizable compound. Further, the photoradical polymerization initiator has very specific properties such that it function as a radical polymerization inhibitor in dark place to prevent unintended radical polymerization, and when irradiated with light having a wavelength within a range of from 350 nm to 420 nm, it loses radical polymerization inhibiting capacity and at the same time functions as a photoradical polymerization initiator, and it has a photobleaching function such that after generating radicals, the conjugated bond of molecules is cleaved and thus it no more absorbs light in the ultraviolet region. Further, the 1,4-dihydroxy-2-naphthoic acid compound is an environmentally friendly compounds composed solely of carbon atoms, hydrogen atoms and oxygen atoms, and is useful as a highly safe photoradical polymerization initiator.

The objects, characteristics and advantages of the present invention will be more apparent by the following description in detail.

### BRIEF DESCRIPTION OF DRAWINGS

FIG. 1 is an absorption curve in UV and visible ranges of phenyl 1,4-dihydroxy-2-naphthoate dissolved in acetonitrile at a 10 ppm concentration. The vertical axis indicates absorbance, and the horizontal axis indicates wavelength (unit: nm).

FIG. 2 is a diagram indicating changes at each pass of absorption spectrum when a photoradical polymerizable composition containing phenyl 1,4-dihydroxy-2-naphthoate is irradiated with 405 nm UV light several times.

FIG. 3 is a diagram indicating changes at each pass of absorption spectrum when a photoradical polymerizable composition containing OMNIRAD TPO is irradiated with 405 nm UV light several times.

FIG. 4 is a diagram indicating changes at each pass of absorption spectrum when a photoradical polymerizable composition containing OMNIRAD 907 is irradiated with 405 nm UV light several times.

FIG. 5 is a diagram indicating changes at each pass of absorption spectrum when a photoradical polymerizable composition containing isopropylthioxanthone is irradiated with 405 nm UV light several times.

### DESCRIPTION OF EMBODIMENTS

Now, the present invention will be described in detail below.

### (Photoradical Polymerization Initiator)

According a first aspect of the present invention, the present invention provides a photoradical polymerizable composition comprising a radical polymerizable compound and a photoradical polymerization initiator, wherein the photoradical polymerization initiator is a 1,4-dihydroxy-2-naphthoic acid compound represented by the following formula (1).

### (1,4-Dihydroxy-2-Naphthoic Acid Compound)

The 1,4-dihydroxy-2-naphthoic acid compound as the photoradical polymerization initiator in the photoradical polymerizable composition of the present invention is represented by the following formula (1).

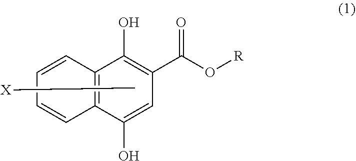

In the formula (1), R is a hydrogen atom, a C₁₋₁₀ alkyl group or a C₆₋₁₄ aryl group, and X is a hydrogen atom, a C₁₋₁₀ alkyl group, a C₆₋₁₄ aryl group, a hydroxy group, a C₁₋₁₀ alkoxy group or a C₆₋₁₄ aryloxy group. The alkyl group or aryl group represented as R may further be substituted by an alkoxy group, a hydroxy group or a (meth)acrylic group.

In the formula (1), the C₁₋₁₀ alkyl group represented as R may, for example, be a linear, branched or cyclic alkyl group such as methyl group, ethyl group, n-propyl group, i-propyl group, n-butyl group, i-butyl group, n-amyl group, i-amyl group, n-hexyl group, n-heptyl group, n-octyl group, 2-ethylhexyl group, n-nonyl group, n-decyl group or cyclohexyl group. The C₆₋₁₄ aryl group may, for example, be a phenyl group, tolyl group, naphthyl group or fluorene group, which may have a substituent.

As specific examples of the compound of the formula (1) wherein R is a hydrogen atom or a C₁₋₁₀ alkyl group, 1,4-dihydroxy-2-naphthoic acid, methyl 1,4-dihydroxy-2-naphthoate, ethyl 1,4-dihydroxy-2-naphthoate, propyl 1,4-dihydroxy-2-naphthoate, butyl 1,4-dihydroxy-2-naphthoate, hexyl 1,4-dihydroxy-2-naphthoate, cyclohexyl 1,4-dihydroxy-2-naphthoate, octyl 1,4-dihydroxy-2-naphthoate, 2-hydroxyethyl 1,4-dihydroxy-2-naphthoate, phenyl 1,4-dihydroxy-2-naphthoate, (4-hydroxyphenyl) 1,4-dihydroxy-2-naphthoate and naphthyl 1,4-dihydroxy-2-naphthoate may be mentioned. Further, ester compounds of 1,4-dihydroxy-2-naphthoic acid with a polyhydric alcohol such as trimethylolpropane, pentaerythritol, polyethylene glycol or polypropylene glycol may, for example, be mentioned.

As specific examples of the compound of the formula (1) wherein X is a C₁₋₁₀ alkyl group, 1,4-dihydroxy-3-methyl-2-naphthoic acid, methyl 1,4-dihydroxy-3-methyl-2-naphthoate, ethyl 1,4-dihydroxy-3-methyl-2-naphthoate, propyl 1,4-dihydroxy-3-methyl-2-naphthoate, butyl 1,4-dihydroxy-3-methyl-2-naphthoate, hexyl 1,4-dihydroxy-3-methyl-2-naphthoate, cyclohexyl 1,4-dihydroxy-3-methyl-2-naphthoate, octyl 1,4-dihydroxy-3-methyl-2-naphthoate, phenyl 1,4-dihydroxy-3-methyl-2-naphthoate, (4-hydroxyphenyl) 1,4-dihydroxy-3-methyl-2-naphthoate and naphthyl 1,4-dihydroxy-3-methyl-2-naphthoate may, for example, be mentioned.

Further, 1,4-dihydroxy-6-methyl-2-naphthoic acid, methyl 1,4-dihydroxy-6-methyl-2-naphthoate, ethyl 1,4-dihydroxy-6-methyl-2-naphthoate, propyl 1,4-dihydroxy-6-methyl-2-naphthoate, butyl 1,4-dihydroxy-6-methyl-2-naphthoate, hexyl 1,4-dihydroxy-6-methyl-2-naphthoate, cyclohexyl 1,4-dihydroxy-6-methyl-2-naphthoate, octyl 1,4-dihydroxy-6-methyl-2-naphthoate, phenyl 1,4-dihydroxy-6-methyl-2-naphthoate, (4-hydroxyphenyl) 1,4-dihydroxy-6-methyl-2-naphthoate, naphthyl 1,4-dihydroxy-6-methyl-2-naphthoate, 1,4-dihydroxy-6-ethyl-2-naphthoic acid, methyl 1,4-dihydroxy-6-ethyl-2-naphthoate, ethyl 1,4-dihydroxy-6-ethyl-2-naphthoate, propyl 1,4-dihydroxy-6-ethyl-2-naphthoate, butyl 1,4-dihydroxy-6-ethyl-2-naphthoate, hexyl 1,4-dihydroxy-6-ethyl-2-naphthoate, cyclohexyl 1,4-dihydroxy-6-ethyl-2-naphthoate, octyl 1,4-dihydroxy-6-ethyl-2-naphthoate, phenyl 1,4-dihydroxy-6-ethyl-2-naphthoate, (4-hydroxyphenyl) 1,4-dihydroxy-6-ethyl-2-naphthoate, naphthyl 1,4-dihydroxy-6-ethyl-2-naphthoate, 1,4-dihydroxy-6-phenyl-2-naphthoic acid, methyl 1,4-dihydroxy-6-phenyl-2-naphthoate, ethyl 1,4-dihydroxy-6-phenyl-2-naphthoate, propyl 1,4-dihydroxy-6-phenyl-2-naphthoate, butyl 1,4-dihydroxy-6-phenyl-2-naphthoate, hexyl 1,4-dihydroxy-6-phenyl-2-naphthoate, cyclohexyl 1,4-dihydroxy-6-phenyl-2-naphthoate, octyl 1,4-dihydroxy-6-phenyl-2-naphthoate, phenyl 1,4-dihydroxy-6-phenyl-2-naphthoate, (4-hydroxyphenyl) 1,4-dihydroxy-6-phenyl-2-naphthoate and naphthyl 1,4-dihydroxy-6-phenyl-2-naphthoate may, for example, be mentioned.

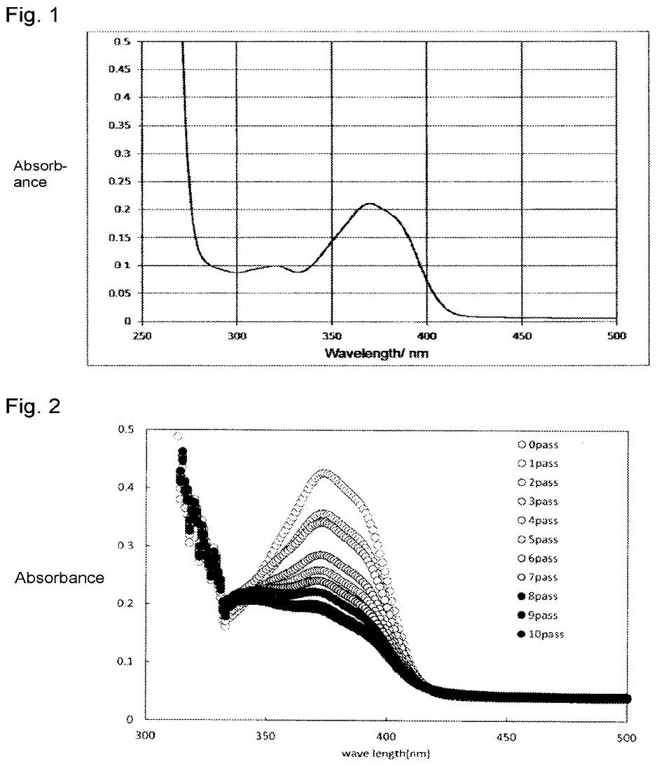

The 1,4-dihydroxy-2-naphthoic acid compound of the present invention is a compound composed solely of carbon atoms, hydrogen atoms and oxygen atoms and has a naphthalene skeleton as its basic skeleton, and has a structure greatly different from conventional photoradical polymerization initiators in that point. And, a compound having a conventional naphthalene skeleton is known to have wavelength absorption only at 350 nm or less, as different from a compound having an anthracene skeleton. However, surprisingly, it was found that the 1,4-dihydroxy-2-naphthoic acid compound has, exceptionally for naphthalene compounds, one of ultraviolet absorption peaks within a wavelength range of from 350 nm to 420 nm. The reason is considered that as shown in FIG. 1 indicating the UV absorption spectrum of the phenyl 1,4-dihydroxy-2-naphthoate, the π-electron system widens, and the electron density of the naphthalene ring is decreased, by the presence of a carboxylic acid group at the 2-position. Thus, the 1,4-dihydroxy-2-naphthoic acid compound is found to be excited and decomposed by light at a wavelength of from 350 nm to 420 nm, which is unexpected of naphthalene compounds, to generate radical species. The mechanism has not been clearly understood yet, but is considered that the 1,4-dihydroxy-2-naphthoic acid compound, from the excited state via intramolecular cleavage, generates radical species, which function as a radical polymerization initiator. It has not been known at all that such a simple aromatic carboxylic acid compound composed solely of carbon atoms, hydrogen atoms and oxygen atoms, such as a 1,4-dihydroxy-2-naphthoic acid compound, functions as a photoradical polymerization initiator.

A 1,4-dialkoxy-2-naphthoic acid compound or the like having a structure analogous to that of the 1,4-dihydroxy-2-naphthoic acid compound, has ultraviolet absorption within a wavelength range of from 350 nm to 420 nm, however, it does not generate radical species even when irradiated with light having such a wavelength and does not function as a photoradical polymerization initiator. Thus, in order that the compound has ultraviolet absorption within a wavelength range of from 350 nm to 420 nm, it is important that the compound has an oxygen atom at the 1,4-positions of the naphthalene skeleton and has a carboxy group at the 2-position, and in order that radical species are generated from the exited state, it is important that the compound has a hydroxy group at the 1,4-positions.

The 1,4-dihydroxy-2-naphthoic acid compound represented by the formula (1) may be produced by esterifying the corresponding 1,4-dihydroxy-2-naphthoic acid by a conventional method. For example, by reacting 1,4-dihydroxy-2-naphthoic acid and phenol in the presence of a dehydrating agent, phenyl 1,4-dihydroxy-2-naphthoate can be synthesized. The 1,4-dihydroxy-2-naphthoic acid may be obtained by reacting 1,4-dihydroxynaphthalene with carbon dioxide gas by a conventional method e.g. by a method disclosed in literature. The reaction is application of a so-called Kolbe-Schmitt reaction of producing salicylic acid from phenol. For example, a method of carboxylating 1,4-dihydroxynaphthalene with carbon dioxide gas in an organic solvent in the presence of particulate anhydrous potassium carbonate (JP-A-S57-126443), a method of carboxylating an alkali metal compound of 1,4-dihydroxynaphthalene with carbon dioxide gas (JP-A-S59-141537, JP-A-H9-132545), etc. have been known. Further, production by fermentation of Propionibacterium may also be mentioned.

As described above, the 1,4-dihydroxy-2-naphthoic acid compound has specific ultraviolet absorption within a wavelength range of from 350 nm to 420 nm, and is thereby excited by such ultraviolet rays, and the excited species generate radical species, and thus the compound has properties as a photoradical polymerization initiator. Further, the 1,4-dihydroxy-2-naphthoic acid compound is an environmentally friendly compound composed solely of carbon atoms, hydrogen atoms and oxygen atoms.

Further, surprisingly, it was found that the 1,4-dihydroxy-2-naphthoic acid compound of the present invention, when irradiated with light within a wavelength range of from 350 nm to 420 nm, generates radical species to function as a radical polymerization initiator thereby to radical-polymerize a radical polymerizable compound, but in dark place without irradiation with light having a wavelength within a range of from 350 nm to 420 nm, on the contrary, it functions as a radical polymerization inhibitor which scavenges radical species.

It is commonly known that a radical polymerizable compound such as methyl acrylate or styrene naturally generates radical species e.g. by oxygen or heat, without a polymerization initiator, and undergoes polymerization deterioration. Thus, to a radical polymerizable compound such as methyl acrylate or styrene, to prevent deterioration, a polymerization preventing agent such as t-butyl catechol is added to scavenge and inactivate the generated radical species. However, at the time of polymerization, the polymerization preventing agent inhibits polymerization on the contrary, and thus lead time of the radical polymerization may be prolonged, or the polymerization reaction may not proceed well. Thus, at the time of polymerization it is necessary to remove the polymerization preventing agent or to add a polymerization initiator in an amount sufficient to inactivate the polymerization preventing agent.

With the radical polymerizable composition containing the 1,4-dihydroxy-2-naphthoic acid compound of the present invention, when unintended radical species are generated by oxygen, heat or the like, the 1,4-dihydroxy-2-naphthoic acid compound of the present invention can scavenge the radical species and prevent polymerization deterioration of the radical polymerizable compound. That is, storage stability of the radical polymerizable compound can be improved. Specifically, a polymerizable composition to be used for a coating material for woodworking, a coating material for e.g. metals, an ink for screen printing and offset printing, a dry film resist to be used for printed circuit boards, and a hologram material, a sealing agent, an overcoating material, a resin for stereolithography, an adhesive, etc., is usually prepared, transported and stored as a polymerizable composition having a photoradical initiator or a heat radical initiator preliminarily added. Such chemically unstable photoradical initiator or heat radical initiator contained will remarkably deteriorate storage stability, and storage at 0° C. or lower is required in many cases. By addition of the 1,4-dihydroxy-2-naphthoic acid compound of the present invention, storage stability which requires no storage under cooling, e.g. storage at room temperature, can be secured. On the other hand, when the radical polymerizable compound is to be made to undergo radical polymerization, the 1,4-dihydroxy-2-naphthoic acid compound of the present invention loses a function to scavenge radicals when irradiated with light having a specific wavelength (light having a wavelength within a range of from 350 nm to 420 nm), and generates radical species to initiate radical polymerization. That is, the 1,4-dihydroxy-2-naphthoic acid compound of the present invention is a compound having a special property such that it can initiate and terminate radical polymerization by the presence of absence of light having a specific wavelength. Further, it is capable of controlling initiation and inhibition of polymerization between a portion exposed to light and a portion not exposed to light.

The difference between the 1,4-dihydroxy-2-naphthoic acid compound of the present invention and other photoradical polymerization initiator is as follows. That is, other photoradical polymerization initiator has a capacity to initiate radical polymerization by irradiation with light having a specific wavelength (under light conditions), but is inactive to radicals and cannot scavenge radicals under dark conditions (under conditions not irradiated with light having a specific wavelength). On the other hand, the 1,4-dihydroxy-2-naphthoic acid compound of the present invention is active to radicals, has a capacity to scavenge generated radicals and has a function as a radical polymerization inhibitor under dark conditions (under conditions not irradiated with light having a specific wavelength). However, when irradiated with light having a specific wavelength, it loses the capacity to scavenge radicals and is inactivated, thereby generates radicals to exhibit a function to initiate radical polymerization. That is, they are the same in that they will not initiate polymerization under dark conditions and bring about polymerization under light conditions, but totally different in that the 1,4-dihydroxy-2-naphthoic acid compound of the present invention positively has a radical polymerization inhibiting capacity under dark conditions.

The 1,4-dihydroxy-2-naphthoic acid compound of the present invention may be used as a storage stabilizer for a radical polymerizable compound by preliminarily added to the radical polymerizable compound. Otherwise, when radical polymerization is to be initiated, it may be added to a radical polymerizable compound so as to control the portion to be polymerized by irradiation with specific light.

For example, in a case where the radical polymerizable composition is applied into a film, and the resulting coating film is covered with a light shielding film having a pattern, and the radical polymerizable composition is irradiated with light within a wavelength range of from 350 to 420 nm to initiate polymerization of the radical polymerizable composition, polymerization proceeds only in a portion exposed to light, and polymerization reaction does not proceed in a portion covered with the light shielding film, whereby a pattern of the polymer can be formed. However, in the case of a commonly used photoradical polymerization initiator, in the vicinity of the shielded portion not irradiated with light, by generated radical species or radicals at the polymerization terminal, polymerization proceeds, the composition is cured also at the portion not exposed to light, and no definite pattern can be formed in many cases. Whereas by incorporating the 1,4-dihydroxy-2-naphthoic acid compound of the present invention, by the polymerization inhibiting effect of the 1,4-dihydroxy-2-naphthoic acid compound of the present invention, at a shielded portion not irradiated with light, radical species are scavenged ant polymerization reaction will not sufficiently proceed, and a portion exposed to light and a portion not exposed to light can be clearly distinguished. Thus, a pattern with a sharp boundary between a portion exposed to light and a portion not exposed to light can be formed.

And, further, surprisingly, the 1,4-dihydroxy-2-naphthoic acid compound of the present invention was found to have photobleaching function such that it absorbs light having a wavelength within a range of from 350 nm to 420 nm and generates radicals to function as a photoradical polymerization initiator, and after generating radicals, the conjugated bond of the molecules is cleaved, and it no more absorbs light in the ultraviolet region. By such an effect, the 1,4-dihydroxy-2-naphthoic acid compound of the present invention can be considered as a very highly useful photoradical polymerization initiator in that its light absorption in the visible region is decreased, and no fluorescence is emitted and as a result, the resulting cured product will hardly be colored, and ultraviolet rays applied are not absorbed and thus the light can be transmitted to the interior, light reaches a deep portion which ultraviolet rays have not reached, and curing will smoothly proceed even in a thick film.

The amount of the 1,4-dihydroxy-2-naphthoic acid compound of the present invention incorporated is, from the viewpoint of the effect as the radical polymerization initiator, sufficient radical polymerization inhibiting effect and economical efficiency, usually preferably from 0.1 to 10 parts by weight, more preferably from 0.2 to 5 parts by weight per 100 parts by weight of the radical polymerizable compound.

### (Other Photoradical Polymerization Initiator (Excluding the 1,4-Dihydroxy-2-Naphthoic Acid Compound))

The above radical polymerization inhibiting effect is exhibited also when other photoradical polymerization initiator coexists. Radical species or radicals at the polymerization terminals generated by other photoradical polymerization initiator or the 1,4-dihydroxy-2-naphthoic acid compound in light place may be scavenged by the 1,4-dihydroxy-2-naphthoic acid compound as the photoradical polymerization initiator in the present invention in dark place to inhibit propagation of polymerization in dark place.

Further, the 1,4-dihydroxy-2-naphthoic acid compound of the present invention has photobleaching function such that it absorbs light having a wavelength within a range of from 350 nm to 420 nm to generate radicals and then it no more absorbs light in the ultraviolet region, and accordingly when other photoradical polymerization initiator coexists, it does not prevent the other photoradical polymerization initiator from being excited by ultraviolet rays, and the other photoradical polymerization initiator can sufficiently exhibit its capacity. Particularly, the 1,4-dihydroxy-2-naphthoic acid compound of the present invention is effective for a photoradical polymerization initiator having ultraviolet absorption at a wavelength close to that of the 1,4-dihydroxy-2-naphthoic acid compound of the present invention.

Accordingly, the photoradical polymerizable composition of the present invention may be used in combination with other photoradical polymerization initiator, excluding an onium salt which is a photocationic polymerization initiator and is also a photoradical polymerization initiator. If an onium salt is used as a radical polymerization initiator, radical polymerization proceeds, however, a Bronsted acid is spontaneously generated from the onium salt by light irradiation, and the acid may cause metal corrosion.

As a photoradical polymerization initiator which can be used in combination with the 1,4-dihydroxy-2-naphthoic acid compound of the present invention, first, photoradical polymerization initiators composed solely of carbon atoms, hydrogen atoms and oxygen atoms, like the 1,4-dihydroxy-2-naphthoic acid compound of the present invention, may be mentioned. As the photoradical polymerization initiators composed solely of carbon atoms, hydrogen atoms and oxygen atoms, an alkylphenone type photoradical polymerization initiator, a benzophenone type radical polymerization initiator, and an anthraquinone type photoradical polymerization initiator may, for example, be mentioned. Among the photoradical polymerization initiators composed solely of carbon atoms, hydrogen atoms and oxygen atoms, in view of synergistic effects, (i) alkylphenone type photoradical polymerization initiator and (ii) benzophenone type radical polymerization initiator are preferred.

### ((i) Alkylphenone Type Photoradical Polymerization Initiator)

The alkylphenone type photoradical polymerization initiator used in the present invention is not particularly limited so long as it has an alkylphenone structure and is exited and decomposed by light irradiation to generate radical species. Its typical structure is represented by the following formula (2):

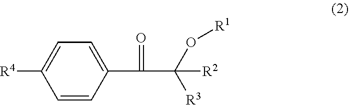

In the formula (2), R¹ is a hydrogen atom, a C₁₋₁₀ alkyl group or a C₅₋₁₂ aryl group, R² and R³ which may be the same or different, is a C₁₋₁₀ alkyl group, a C₅₋₁₂ aryl group, a C₁₋₁₀ alkoxy group or a C₅₋₁₂ aryloxy group, provided that R² and R³ together may be bonded to form a ring, or R² and R³ together may be ═O. R⁴ is a hydrogen atom, a C₁₋₁₀ alkyl group, a C₅₋₁₂ aryl group, a C₇₋₁₅ aralkyl group, a C₁₋₁₀ alkoxy group or a C₅₋₁₂ aryloxy group, provided that such an alkyl group, aryl group or aralkyl group may further have a substituent composed of carbon atoms and oxygen atoms.

In the formula (2), as the C₁₋₁₀ alkyl group represented as each of R¹, R², R³ and R⁴ may, for example, be a linear, branched or cyclic alkyl group such as methyl group, ethyl group, n-propyl group, i-propyl group, n-butyl group, i-butyl group, n-amyl group, i-amyl group, n-hexyl group, n-heptyl group, n-octyl group, 2-ethylhexyl group, n-nonyl group, n-decyl group or cyclohexyl group. The C₅₋₁₂ aryl group may, for example, be a phenyl group, tolyl group or naphthyl group, which may have a substituent. The C₁₋₁₀ alkoxy group may, for example, be a linear, branched or cyclic alkoxy group such as methoxy group, ethoxy group, propoxy group, butoxy group, pentoxy group, hexyloxy group, heptyloxy group, octyloxy group, 2-ethylhexyloxy group, nonyloxy group, decyloxy group or cyclohexyloxy group. The C₅₋₁₂ aryloxy group may, for example, be a phenyloxy group, tolyloxy group or naphthyloxy group, which may have a substituent. The ring formed by R² and R³ may, for example, be a cyclohexane ring. The C₇₋₁₅ aralkyl group represented as R⁴ may, for example, be a benzyl group, a naphthylmethyl group or a phenethyl group.

As examples of the alkylphenone type photoradical polymerization initiator, various compounds have been known, and among them, at least one member selected from the group consisting of 1-hydroxycyclohexyl phenyl ketone, 2-hydroxy-2-methyl-1-phenylpropan-1-one, 1-[4-(2-hydroxyethoxy)phenyl]-2-hydroxy-2-methylpropan-1-one, 2-hydroxy-1-{[4-(2-hydroxy-2-methylpropionyl)benzyl]phenyl}-2-methylpropan-1-one and 2,2-dimethoxy-1,2-diphenylethan-1-one is preferred, and 1-hydroxycyclohexyl phenyl ketone is most preferred. As commercial products of the alkylphenone type photoradical polymerization initiator, OMNIRAD 184 (OMNIRAD is a registered trademark of IGM Group B.V.), OMNIRAD 1173, OMNIRAD 2959, OMNIRAD 127, OMNIRAD 651 may, for example, be mentioned. OMNIRAD MBF (an example of a compound wherein R² and R³ together form ═O) and OMNIRAD 754, having a structure analogous to that of the alkylphenone type photoradical polymerization initiator, may also be mentioned.

The alkylphenone type photoradical polymerization initiator of the present invention is composed solely of carbon atoms, hydrogen atoms and oxygen atoms and is characterized in that coloring is less likely to occur at the time of curing, and a cured coating film has high adhesion to a substrate. Whereas the alkylphenone type photoradical polymerization initiator has weak light absorption at a wavelength within a range of from 350 nm to 420 nm and has low activity as a photoradical polymerization initiator to energy rays including light within such a range. However, by using the alkylphenone type photoradical polymerization initiator and the 1,4-dihydroxy-2-naphthoic acid compound of the present invention in combination, not only activity as a photoradical polymerization initiator improves and the polymerization rate by the alkylphenone type photoradical polymerization initiator improves but also synergistic effects such as improvement of the surface hardness can be expected.

The 1,4-dihydroxy-2-naphthoic acid compound of the present invention has a capacity to initiate polymerization of the radical polymerizable compound by energy rays with a wavelength within a range of from 350 nm to 420 nm even under conditions where no photoradical polymerization initiator such as an alkylphenone type photoradical polymerization initiator is present. For example phenyl 1,4-dihydroxy-2-naphthoate has an initiation capacity higher than that of 2-isopropylthioxanthone (ITX) and an α-aminoacetophenone type photoradical polymerization initiator (OMNIRAD 907) considered to have high activity within the above wavelength range and has very high photoradical polymerization initiation capability for a photoradical polymerization initiator composed solely of carbon atoms, hydrogen atoms and oxygen atoms. Further, by using the 1,4-dihydroxy-2-naphthoic acid compound of the present invention and the alkylphenone type photoradical polymerization initiator in combination as the photoradical polymerization initiator, the photoradical polymerization rate will further improve. Further, by improving physical properties particularly the weight average molecular weight and the number average molecular weight of a photopolymerized product (cured product), mechanical strength such as tensile strength will further improve. Further, e.g. hardness of a polymerized product will improve. Strength of a polymer material is a practically very important property and is known to increase as the molecular weight increases (Nobuhiko Nakano, Sumiko Hasegawa, “Effect of Molecular Weight on Tensile Strength of Polystyrene”, Materials, 33 (372), 1206-1212, 1984).

The above effects are considered as follows. That is, by using the 1,4-dihydroxy-2-naphthoic acid compound as the photoradical polymerization initiator of the present invention and the alkylphenone type photoradical polymerization initiator in combination, the polymerization initiation rates of the respective photoradical polymerization initiators are moderately different from each other. Thus, for example in a photopolymerizable composition containing a polymerizable resin, an unpolymerized polymerizable composition infiltrates into a polymerized and shrunk resin and is polymerized, whereby shrinkage on curing of the photopolymerized product can be reduced, and further, polymerization at the later stage will form a sufficient crosslinked structure on the surface, and thus polymerization termination reaction is less likely to occur. As a result, the photopolymerized product has a high molecular weight and has a high surface hardness.

Further, by using the 1,4-dihydroxy-2-naphthoic acid compound and the alkylphenone type photoradical polymerization initiator in combination, ultraviolet absorption in a wider wavelength range becomes possible, and further improvement in the polymerization rate by irradiation e.g. by a high pressure mercury lamp with absorption at many wavelengths is expected.

((ii) Benzophenone Type Photoradical Polymerization Initiator)

The benzophenone type photoradical polymerization initiator used in the present invention is not particularly limited so long as it has a benzophenone structure and is excited by light irradiation to cause hydrogen withdrawal to generate radical species. Its typical structure is represented by the following formula (3).

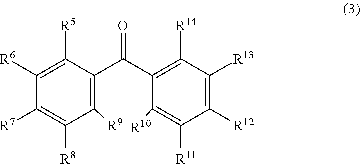

In the formula (3), R⁵ to R¹⁴ are each independently a hydrogen atom, a C₁₋₁₀ alkyl group, a C₁₋₁₀ alkoxy group, a C₁₋₁₀ acyl group, a C₁₋₁₀ acyloxy group, a C₅₋₁₂ aryl group, a C₅₋₁₂ aryloxy group, a hydroxy group, a vinyl group, an alkylcarbonyl group having a C₁₋₁₀ alkyl group, an arylcarbonyl group having a C₆₋₁₅ aryl group, an alkylcarbonyl group having a C₁₋₁₀ alkyl group or an aryloxy carbonyl group having a C₆₋₁₅ aryl group. R⁵ to R¹⁴ may be the same or different. Further, two substituents adjacent via a carbon atom on the aromatic ring may be bonded to form a cyclic structure with the carbon atom. Further, R⁹ and R¹⁰ may be bonded directly or via an oxygen atom to form a cyclic structure with the oxygen atom.

In the formula (3), the C₁₋₁₀ alkyl group represented as each of R⁵ to R¹⁴ may be a linear, branched or cyclic alkyl group such as methyl group, ethyl group, n-propyl group, i-propyl group, n-butyl group, i-butyl group, n-amyl group, i-amyl group, n-hexyl group, n-heptyl group, n-octyl group, 2-ethylhexyl group, n-nonyl group, n-decyl group or cyclohexyl group. The C₅₋₁₂ aryl group may, for example, be a phenyl group, tolyl group or naphthyl group, which may have a substituent. The C₁₋₁₀ alkoxy group may be a linear, branched or cyclic alkoxy group such as methoxy group, ethoxy group, propoxy group, butoxy group, pentoxy group, hexyloxy group, heptyloxy group, octyloxy group, 2-ethylhexyloxy group, nonyloxy group, decyloxy group or cyclohexyloxy group. The C₅₋₁₂ aryloxy group may be a phenyloxy group, tolyloxy group or naphthyloxy group, which may have a substituent.

The alkylcarbonyl group having a C₁₋₁₀ alkyl group may, for example, be acetyl group, propionyl group, n-butanoyl group, iso-butanoyl group, n-pentanoyl group, n-hexanoyl group, n-heptanoyl group, n-octanoyl group, 2-ethylhexanoyl group, n-nonanoyl group or n-decanoyl group. The arylcarbonyl group having a C₆₋₁₅ aryl group may, for example, be a benzoyl group or a naphthoyl group.

The alkyloxycarbonyl group having a C₁₋₁₀ alkyl group may be a linear, branched or cyclic alkyloxycarbonyl group such as methoxycarbonyl group, ethoxycarbonyl group, n-propyloxycarbonyl group, isopropyloxycarbonyl group, n-butoxycarbonyl group, i-butoxycarbonyl group, sec-butoxycarbonyl group, tert-butoxycarbonyl group, n-pentyloxycarbonyl group, 2,2-dimethylpropyloxycarbonyl group, cyclopentyloxycarbonyl group, n-hexyloxycarbonyl group, cyclohexyloxycarbonyl group, n-heptyloxycarbonyl group, 2-methylpentyloxycarbonyl group, n-octyloxycarbonyl group, 2-ethylhexyloxycarbonyl group, n-nonyloxycarbonyl group, n-decyloxycarbonyl group, or cyclohexyloxycarbonyl group. The aryloxycarbonyl group having a C₆₋₁₅ aryl group may, for example, be a phenoxycarbonyl group, a 1-naphthyloxycarbonyl group or a 2-naphthyloxycarbonyl group. The ring formed by R² and R³ may, for example, be a cyclohexane ring.

As examples of the benzophenone type photoradical polymerization initiator, various compounds are known, and among them, preferred is at least one member selected from the group consisting of benzophenone, benzoyl benzoate, methyl o-benzoyl benzoate, 4-phenylbenzophenone, 4-methoxybenzophenone, 4-hydroxybenzophenone, 4,4′-dihydroxybenzophenone, acrylated benzophenone, 4-methylbenzophenone, 4,4′-dimethylbenzophenone, 4,4′-dimethoxybenzophenone, 3,3′-dimethyl-4-methoxybenzophenone, 2,4,6-trimethylbenzophenone, 3,3,4,4′-tetra(t-butylperoxycarbonyl)benzophenone, 4,4′-diphenoxybenzophenone and fluorenone. Further, a chain polymer compound, branched polymer compound or dendrimer having the above benzophenone compound in the main chain, at the terminal or in its side chain. Among such compounds, methyl o-benzoyl benzoate, benzophenone, or 4-phenylbenzophenone is most preferred. As commercial products of the benzophenone type photoradical polymerization initiator, OMNIRAD 4PBZ (OMNIRAD is a registered trademark of IGM Group B.V.), OMNIRAD OMBB, etc., may be mentioned.

The benzophenone type photoradical polymerization initiator is known not only to be composed solely of carbon atoms, hydrogen atoms and oxygen atoms but also to provide a cured coating film having high adhesion.

The benzophenone type photoradical polymerization initiator has weak light absorption at a wavelength within a range of from 350 nm to 420 nm in the same manner as the alkylphenone type photoradical polymerization initiator and has low activity to energy rays including light within the above range, as the photoradical polymerization initiator. However, by using the benzophenone type photoradical polymerization initiator and the 1,4-dihydroxy-2-naphthoic acid compound of the present invention in combination, activity as the radical polymerization initiator further improves, and not only the polymerization rate by the benzophenone type photoradical polymerization initiator will improve but also synergistic effects such as improvement of the adhesion of a cured coating film can be expected.

Further, by using the 1,4-dihydroxy-2-naphthoic acid compound of the present invention and the benzophenone type photoradical polymerization initiator in combination, ultraviolet absorption within a wider wavelength range becomes possible, and further improvement of the polymerization rate by a multi-wavelength irradiation source such as a high pressure mercury lamp can be expected.

Depending upon application, a benzophenone type photoradical polymerization initiator having a hetero atom or a halogen atom may also be used. The benzophenone type photoradical polymerization initiator having a hetero atom or a halogen atom may, for example, be 2,4-dichlorobenzophenone, 2,4′-dichlorobenzophenone, 4,4′-dichlorobenzophenone, 4,4′-bis(dimethylamino)benzophenone, 4,4′-bis(diethylamino)benzophenone, 4-benzoyl-4′-methyldiphenyl sulfide or 4,4′-morpholinobenzophenone.

Further, depending upon application, a photoradical polymerization initiator containing an atom of concern about environmental problems such as a nitrogen atom, a sulfur atom or a phosphorus atom may be used in combination. For example, as the photoradical polymerization initiator which can be used in combination in the present invention, an acylphosphine oxide type photoradical polymerization initiator, an oxime ester type photoradical polymerization initiator, an α-aminoacetophenone type photoradical polymerization initiator, a triazine type photoradical polymerization initiator, a thioxanthone type photoradical polymerization initiator, a biimidazole type photoradical polymerization initiator and an acridine type photoradical polymerization initiator may, for example, be mentioned. Among them, (iv) acylphosphine oxide type photoradical polymerization initiator and (v) oxime ester type photoradical polymerization initiator are preferred, by which high sensitivity by use in combination can be expected. Further, (vi) biimidazole type photoradical polymerization initiator is particularly preferred since not only an increase of the curing rate by use in combination but also synergistic effects such that the curing rate can be increased without using a reducing agent such as Leuco Crystal Violet can be expected. Further, the above mentioned photoradical polymerization initiators are compounds containing an atom of concern about environmental problems such as a nitrogen atom, a sulfur atom or a phosphorus atom, however, its amount can be reduced and the environmental burden can be reduced by using the 1,4-dihydroxy-2-naphthoic acid compound as the photoradical polymerization initiator of the present invention in combination.

Many of the photoradical polymerization initiators mentioned above have ultraviolet absorption at from 350 nm to 420 nm by containing a nitrogen atom, a sulfur atom or a phosphorus atom, and many of them have high activity to light within such a wavelength range, however, when the 1,4-dihydroxy-2-naphthoic acid compound as the photoradical polymerization initiator of the present invention is used in combination, there may be a fear that the initiators compete for the light absorption and thus their activities may not sufficiently be achieved. However, the 1,4-dihydroxy-2-naphthoic acid compound of the present invention has photobleaching function such that it absorbs light having a wavelength within a range of from 350 nm to 420 nm and generates radicals and then it no more absorbs light in the ultraviolet region, and thus even when other photoradical polymerization initiator coexists, excitation of the other photoradical polymerization initiator by ultraviolet rays will not be inhibited, and the other photoradical polymerization initiator can sufficiently exhibit its capacity. Further, since the 1,4-dihydroxy-2-naphthoic acid compound of the present invention function as the photoradical polymerization initiator at the initial stage of photoradical polymerization, and then it undergoes photobleaching and no more absorbs light at the above wavelength. Thus, utilizing the function of the other photoradical polymerization initiator as the photoradical polymerization initiator at the latter stage, it is possible to produce a material inclined in the thickness direction.

((iv) Acylphosphine Oxide Type Photoradical Polymerization Initiator)

The acylphosphine oxide type photoradical polymerization initiator used in the present invention is not particularly limited so long as it has a phenyl bisacylphosphine oxide structure and is excited and decomposed by light irradiation to generate radical species. Its typical structure is represented by the following formula (4).

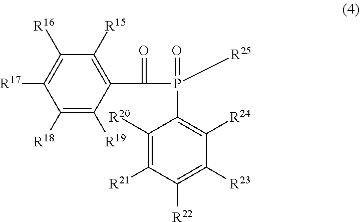

In the formula (4), R¹⁵ to R²⁴ are each independently a hydrogen atom, a C₁₋₁₀ alkyl group, a C₁₋₁₀ alkoxy group, a C₅₋₁₂ aryl group, a C₅₋₁₂ aryloxy group, an alkylcarbonyl group having a C₁₋₁₀ alkyl group, an arylcarbonyl group having a C₆₋₁₅ aryl group, an alkyloxycarbonyl group having a C₁₋₁₀ alkyl group, or an aryloxycarbonyl group having a C₆₋₁₅ aryl group. R²⁵ is a C₁₋₁₀ alkyl group, C₁₋₁₀ alkoxy group, C₁₋₁₀ acyl group, C₅₋₁₂ aryl group, C₅₋₁₂ aryloxy group, alkylcarbonyl group having a C₁₋₁₀ alkyl group, arylcarbonyl group having a C₆₋₁₅ aryl group, alkyloxycarbonyl group having a C₁₋₁₀ alkyl group or an aryloxycarbonyl group having a C₆₋₁₅ aryl group, which may have a substituent.

In the formula (4), the C₁₋₁₀ alkyl group represented as each of R¹⁵ to R²⁴ may be a linear, branched or cyclic alkyl group such as methyl group, ethyl group, n-propyl group, i-propyl group, n-butyl group, i-butyl group, n-amyl group, i-amyl group, n-hexyl group, n-heptyl group, n-octyl group, 2-ethylhexyl group, n-nonyl group, n-decyl group or cyclohexyl group. The C₅₋₁₂ aryl group my, for example, be a phenyl group, tolyl group or naphthyl group, which may have a substituent. The C₁₋₁₀ alkoxy group may be a linear, branched or cyclic alkoxy group such as methoxy group, ethoxy group, propoxy group, butoxy group, pentoxy group, hexyloxy group, heptyloxy group, octyloxy group, 2-ethylhexyloxy group, nonyloxy group, decyloxy group or cyclohexyloxy group. The C₅₋₁₂ aryloxy group may be a phenyloxy group, tolyloxy group or naphthyloxy group, which may have a substituent.

The alkylcarbonyl group having a C₁₋₁₀ alkyl group may, for example, be acetyl group, propionyl group, n-butanoyl group, iso-butanoyl group, n-pentanoyl group, n-hexanoyl group, n-heptanoyl group, n-octanoyl group, 2-ethylhexanoyl group, n-nonanoyl group or n-decanoyl group. The aryl carbonyl group having a C₆₋₁₅ aryl group may, for example, be a benzoyl group or naphthoyl group, which may have a substituent.

The alkyloxycarbonyl group having a C₁₋₁₀ alkyl group may be a linear, branched or cyclic alkyloxycarbonyl group such as methoxycarbonyl group, ethoxycarbonyl group, n-propyloxycarbonyl group, isopropyloxycarbonyl group, n-butoxycarbonyl group, i-butoxycarbonyl group, sec-butoxycarbonyl group, tert-butoxycarbonyl group, n-pentyloxycarbonyl group, 2,2-dimethylpropyloxycarbonyl group, cyclopentyloxycarbonyl group, n-hexyloxycarbonyl group, cyclohexyloxycarbonyl group, n-heptyloxycarbonyl group, 2-methylpentyloxycarbonyl group, n-octyloxycarbonyl group, 2-ethylhexyloxycarbonyl group, n-nonyloxycarbonyl group, n-decyloxycarbonyl group or cyclohexyloxycarbonyl group. The aryloxycarbonyl group having a C₆₋₁₅ aryl group may, for example, be a phenoxycarbonyl group, a 1-naphthyloxycarbonyl group or a 2-naphthyloxycarbonyl group.

As the acylphosphine oxide type photoradical polymerization initiator, various compounds have been known, and among them, preferred is at least one member selected from the group consisting of benzoyl-diphenylphosphine oxide, 2,4,6-trimethylbenzoyl-diphenylphosphine oxide, 2,3,5,6-tetramethylbenzoyl-diphenylphosphine oxide, 3,4-dimethylbenzoyl-diphenylphosphine oxide, 2,4,6-trimethylbenzoyl-phenylethoxyphosphine oxide, bis(2,4,6-trimethylbenzoyl)-phenylphosphine oxide, bis(2,6-dimethoxybenzoyl)-2,4,4-trimethyl-pentylphosphine oxide and bis(2,6-dimethylbenzoyl)-ethylphosphine oxide. As commercial products of the acylphosphine oxide type photoradical polymerization initiator, OMNIRAD TPO, OMNIRAD TPO-L, OMNIRAD 819 etc. may be mentioned.

### ((v) Oxime Ester Type Photoradical Polymerization Initiator)

The oxime ester type photoradical polymerization initiator used in the present invention is not particularly limited so long as it has an oxime ester structure and is excited and decomposed by light irradiation to generate radical species. Its typical structure is represented by the following formula (5).

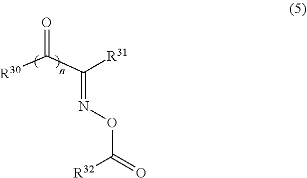

In the formula (5), R³⁰, R³¹ and R³² are each independently a C₁₋₁₀ alkyl group or a C₆₋₂₀ aryl group. The aryl group may be a heterocyclic ring containing an oxygen atom, a sulfur atom, a nitrogen atom or the like, the aryl group may be substituted by an alkyl group, aryl group, alkoxy group, aryloxy group, arylthiol group, aryl vinyl group, alkylcarbonyl group or arylcarbonyl group, which may have a substituent, and may be substituted by a halogen atom, a cyano group or a nitro group. n is an integer of 0 or 1.

In the formula (5), the C₁₋₁₀ alkyl group represented as each of R³⁰, R³¹ and R³² may be a linear, branched or cyclic alkyl group such as methyl group, ethyl group, n-propyl group, i-propyl group, n-butyl group, i-butyl group, n-amyl group, i-amyl group, n-hexyl group, n-heptyl group, n-octyl group, 2-ethylhexyl group, n-nonyl group, n-decyl group or cyclohexyl group. The C₆₋₂₀ aryl group may, for example, be a phenyl group, tolyl group, biphenyl group, phenoxyphenyl group, phenylthiophenyl group, naphthyl group, anthracenyl group, fluorenyl group, benzofuranyl group, dibenzothiophenyl group, carbazole group or benzocarbazole group, which may have a substituent.

As the oxime ester type photoradical polymerization initiator, various compounds have been known, and among them, preferred is at least one member selected from the group consisting of N-benzoyloxy-1-(4-phenylsulfanylphenyl)octan-1-one-2-imine, N-acetyloxy-1-(4-phenylsulfanylphenyl)-3-cyclohexylpropan-1-one-2-imine, N-acetoxy-1-[9-ethyl-6-{2-methyl-4-(3,3-dimethyl-2,4-dioxacyclopentanyl methyloxy)benzoyl}-9H-carbazol-3-yl]ethane-1-imine and 1-[7-(2-methylbenzoyl)-9,9-dipropyl-9H-fluoren-2-yl]ethanone O-acetyloxime. As commercial products of the oxime ester type photoradical polymerization initiator, Irgacure OXE01, Irgacure OXE02, Irgacure OXE03, etc. may be mentioned.

The acylphosphine oxide type photoradical polymerization initiator and the oxime ester type photoradical polymerization initiator are initiators which absorb light within a range of from 350 nm to 420 nm and are excited and cleaved to efficiently generate radical species. On the other hand, by using the acylphosphine oxide type photoradical polymerization initiator and/or the oxime ester type photoradical polymerization initiator, and the 1,4-dihydroxy-2-naphthoic acid compound of the present invention, in combination, the polymerization rate of the radical polymerizable compound can further be improved, and a time until the polymerization starts, that is the induction period can be shortened. Since the acylphosphine oxide type photoradical polymerization initiator changes into a substance which has no or weak absorption to light within a range of from 350 nm to 420 nm, as it is photolyzed, and accordingly by use in combination, curing at deep portion will be accelerated. Since the oxime ester type photoradical polymerization initiator is decarboxylated as it is photolyzed to generate methyl radicals or phenyl radicals having a low molecular weight, that is having high mobility and high polymerization initiation activity, improvement of curing property in a system such that the composition has a high viscosity or in a system such that a pigment is contained, and curing at deep portion can be expected.

Some of the acylphosphine oxide type photoradical polymerization initiators and the oxime ester type photoradical polymerization initiators are known to be photoradical polymerization initiators having photobleaching effect, and the 1,4-dihydroxy-2-naphthoic acid compound as the photoradical polymerization initiator of the present invention also has photobleaching effect. Thus, by using both as the photoradical polymerization initiator, curing at deep portion on a thicker film will be further accelerated, and prevention of the polymerized and cured film from being colored is expected.

((vi) Biimidazole Type Photoradical Polymerization Initiator)

The biimidazole type photoradical polymerization initiator used in the present invention is not particularly limited so long as it has a biimidazole structure and is excited and decomposed by light irradiation to generate radical species. Its typical structure is represented by the following formula (6).

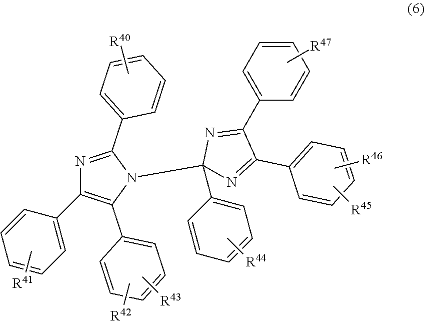

In the formula (6), R⁴⁰ to R⁴⁷ are each independently a hydrogen atom, a C₁₋₁₀ alkyl group, C₆₋₁₀ aryl group, C₁₋₁₀ alkoxy group or C₆₋₁₂ aryloxy group, which may have a substituent, a cyano group or a halogen atom.

In the formula (6), the C₁₋₁₀ alkyl group represented as each of R⁴⁰ to R⁴⁷ may be a linear, branched or cyclic alkyl group such as a methyl group, ethyl group, n-propyl group, i-propyl group, n-butyl group, i-butyl group, n-amyl group, i-amyl group, n-hexyl group, n-heptyl group, n-octyl group, 2-ethylhexyl group, n-nonyl group, n-decyl group or cyclohexyl group. The C₆₋₁₂ aryl group may, for example, be a phenyl group, tolyl group or naphthyl group, which may have a substituent. The C₁₋₁₀ alkoxy group may be a linear, branched or cyclic alkoxy group such as methoxy group, ethoxy group, propoxy group, butoxy group, pentoxy group, hexyloxy group, heptyloxy group, octyloxy group, 2-ethylhexyloxy group, nonyloxy group, decyloxy group or cyclohexyloxy group. The C₆₋₁₂ aryloxy group may be a phenyloxy group, tolyloxy group or naphthyloxy group, which may have a substituent.

The biimidazole type photoradical polymerization initiator may, for example, be a 2,4,5-triaylimidazole dimer such as 2-(o-chlorophenyl)-4,5-diphenylimidazole dimer, 2-(o-chlorophenyl)-4,5-di(methoxyphenyl)imidazole dimer, 2-(o-fluorophenyl)-4,5-diphenylimidazole dimer, 2-(o-methoxyphenyl)-4,5-diphenylimidazole dimer or 2-(p-methoxyphenyl)-4,5-diphenylimidazole dimer.

The biimidazole type photoradical polymerization initiator forms two molecules of imidazolyl radicals by uniform cleave of the C—N bond linking the two imidazole rings by irradiation with ultraviolet rays. The imidazolyl radicals withdraw hydrogen from other compound, and the compound having hydrogen withdrawn acts as initiation radicals to initiate polymerization. Thus, when the biimidazole type photoradical polymerization initiator is used, usually a hydrogen donor (reducing agent) is added. As the hydrogen donor (reducing agent), for example, bis[4-(dimethylamino)phenyl]methane, bis[4-(diethylamino)phenyl]methane, N-phenylglycin, Leuco Crystal Violet, etc. may be used, but they are problematic in storage stability. For example, a radical polymerizable composition containing the biimidazole type photoradical polymerization initiator and Leuco Crystal Violet may undergo curing only in one week even in a brown bottle. However, by using the 1,4-dihydroxy-2-naphthoic acid compound as the photoradical polymerization initiator of the present invention and the biimidazole type photoradical polymerization initiator in combination, radical polymerization can be initiated at a high speed without coexistence of a hydrogen donor (reducing agent) such as Leuco Crystal Violet. The mechanism has not clearly been understood yet, but is considered that reducing property of the hydroquinone structure of the 1,4-dihydroxy-2-naphthoic acid compound is involved.

Also with respect to polymerization initiators other than the photoradical polymerization initiator, by using the 1,4-dihydroxy-2-naphthoic acid compound as the photoradical polymerization initiator of the present invention in combination, such effects can be expected that activity by irradiation with light at a wavelength within a range of from 350 nm to 420 nm may improve, the amount of use may be reduced, the pattern forming capacity may improve, and storage stability of the radical polymerizable composition improves.

The anthraquinone photoradical polymerization initiator which may be used in the present invention may, for example, be 2-ethylanthraquinone, 2-t-butylanthraquinone, 2-phenoxyanthraquinone, 2-(phenylthio)anthraquinone, or 2-(hydroxyethylthio)anthraquinone.

The α-aminoacetophenone type photoradical polymerization initiator may, for example, be 2-methyl-1-[4-(methylthio)phenyl]-2-morpholinopropan-1-one (trade name: OMNIRAD 907), 2-benzyl-2-(dimethylamino)-4′-morpholinobutyrophenone (trade name: OMNIRAD 369), or 2-dimethylamino-2-(4-methylbenzyl)-1-(4-morpholin-4-yl-phenyl)butan-1-one (trade name: OMNIRAD 379).

The triazine type photoradical polymerization initiator may, for example, be 2-(3,4-methylenedioxyphenyl)-4,6-bis(trichloromethyl)-1,3,5-triazine, or 2-(4-methoxyphenyl)-4,6-bis(trichloromethyl)-1,3,5-triazine.

The thioxanthone type polymerization initiator may, for example, be 2,4-diethylthioxanthone or 2-isopropylthioxanthone.

The acridine type photoradical polymerization initiator may, for example, be acridine, 1,7-bis(9,9′-acridinyl)heptane, 9-phenylacridine, 1,6-bis(9-acridinyl)hexane, 1,7-bis(9-acridinyl)heptane, 1,8-bis(9-acridinyl)ocatane, 1,9-bis(9-acridinyl)nonane, 1,10-bis(9-acridinyl)decane, 1,11-bis(9-acridinyl)undecane or 1,12-bis(9-acridinyl)dodecane.

As described above, the 1,4-dihydroxy-2-naphthoic acid compound of the present invention alone has excellent activity as the photoradical polymerization initiator, and by using other photoradical polymerization initiator (excluding the 1,4-dihydroxy-2-naphthoic acid compound) in combination, by synergistic effects of the photoradical polymerization initiators, the radical polymerizable compound can be polymerized at a higher speed, and further, application to a high viscosity system or a system containing a pigment becomes possible, and various physical properties such as surface properties and curing at deep portion may be improved.

The addition ratio of other photoradical polymerization initiator (excluding the 1,4-dihydroxy-2-naphthoic acid compound) to the 1,4-dihydroxy-2-naphthoic acid compound of the present invention is not particularly limited, and in order to achieve the radical polymerization inhibiting effect in dark place, the blend ratio of the 1,4-dihydroxy-2-naphthoic acid compound of the present invention to the photoradical polymerization initiator (excluding the 1,4-dihydroxy-2-naphthoic acid compound) is preferably within a range of from 99:1 to 1:99 by the weight ratio. Further, such effects may be achieved even with a small addition amount of the 1,4-dihydroxy-2-naphthoic acid compound, considering the economical efficiency, the blend ratio may be within a range of from 50:50 to 1:99, or may be within a range of from 10:90 to 1:99, by the weight ratio. Further, in the case of a photoradical polymerization initiator containing a nitrogen atom, a sulfur atom, a phosphorus atom or the like, also for the purpose of reducing its addition amount, the 1,4-dihydroxy-2-naphthoic acid compound of the present invention is preferably used in combination, and in such a case, the blend ratio may be within a range of from 50:50 to 99:1 by the weight ratio.

### (Radical Polymerizable Compound)

The radical polymerizable compound used for the photoradical polymerizable composition of the present invention is not particularly limited so long as it has radical polymerizability, and may, for example, be styrene, p-hydroxystyrene, vinyl acetate, acrylic acid, methacrylic acid, acrylonitrile, methacrylonitrile, acrylamide, an acrylic acid ester or a methacrylic acid ester, and/or an oligomer thereof.

The acrylic acid ester may be a monofunctional acrylate having one acrylate group or a bifunctional acrylate or multifunctional acrylate having two or more acrylate groups. The monofunctional acrylate may, for example, be methyl acrylate, n-butyl acrylate, cyclohexyl acrylate, 2-ethylhexyl acrylate, 2-hydroxyethyl acrylate, phenoxypolyethylene glycol acrylate, 2-acryloyloxyethyl succinate, isostearyl acrylate, 2-(2-ethoxyethoxy)ethyl acrylate, stearyl acrylate, isobornyl acrylate (IBOA), tetrahydrofurfuryl acrylate, lauryl acrylate, 2-phenoxyethyl acrylate, isodecyl acrylate, isooctyl acrylate, tridecyl acrylate, caprolactone acrylate, ethoxylated nonylphenyl acrylate, isobornyl acrylate, 2-hydroxyethyl acrylate, 2-hydroxypropyl acrylate, 4-hydroxybutyl acrylate, isobutyl acrylate, t-butyl acrylate, cyclohexyl acrylate, 2-methoxyethyl acrylate, methoxytriethylene glycol acrylate, 2-ethoxyethyl acrylate, benzyl acrylate, 3,3,5-trimethylcyclohexyl acrylate (TMCHA) or dicyclopentenyl acrylate (DCPA). The bifunctional acrylate may, for example, be ethoxylated bisphenol A diacrylate, 9,9-bis[4-(2-acryloyloxyethoxy)phenyl]fluorene, tricyclodecanedimethanol diacrylate, 1,10-decanediol diacrylate, 1,9-nonanediol diacrylate, dipropylene glycol diacrylate, tripropylene glycol diacrylate, 1,3-butylene glycol diacrylate, 1,4-butanediol diacrylate, diethylene glycol diacrylate, 1,6-hexanediol diacrylate, tetraethylene glycol diacrylate, triethylene glycol diacrylate, tripropylene glycol diacrylate, ethoxylated (3) bisphenol A diacrylate or alkoxylated neopentyl glycol diacrylate.

The multifunctional acrylate may, for example, be ethoxylated isocyanurate triacrylate, ε-caprolactone modified tris-(2-acryloxyethyl) isocyanurate, pentaerythritol triacrylate, trimethylolpropane triacrylate, ditrimethylolpropane tetraacrylate, ethoxylated pentaerythritol tetraacrylate, pentaerythritol tetraacrylate, dipentaerythritol hexaacrylate, tris(2-hydroxyethyl)isocyanurate triacrylate, ethoxylated trimethylolpropane triacrylate, pentaerythritol triacrylate, pentaerythritol tetraacrylate, ditrimethylolpropane tetraacrylate or dipentaerythritol pentaacrylate. Further, epoxy acrylate, urethane acrylate, polyester acrylate, polybutadiene acrylate, polyol acrylate, polyether acrylate, silicone resin acrylate, imide acrylate and the like may also be used.

Likewise, as a methacrylate compound, a monofunctional methacrylate, a bifunctional methacrylate or a multifunctional methacrylate may, for example, be mentioned. The monofunctional methacrylate may, for example, be methyl methacrylate, n-butyl methacrylate, cyclohexyl methacrylate, 2-ethylhexyl methacrylate, 2-hydroxyethyl methacrylate, phenoxyethylene glycol methacrylate, stearyl methacrylate, 2-methacryloyloxyethyl succinate, tetrahydrofurfuryl methacrylate, isodecyl methacrylate, lauryl methacrylate, 2-phenoxyethyl methacrylate, isobornyl methacrylate or tridecyl methacrylate. The bifunctional methacrylate may, for example, be ethylene glycol dimethacrylate, diethylene glycol dimethacrylate, triethylene glycol dimethacrylate, ethoxylated bisphenol A dimethacrylate, tricyclodecane dimethanol dimethacrylate, 1,6-hexanediol dimethacrylate, 1,9-nonanediol dimethacrylate, neopentyl glycol dimethacrylate, glycerin dimethacrylate, tetraethylene glycol dimethacrylate, polyethylene glycol dimethacrylate, 1,4-butanediol dimethacrylate, diethylene glycol dimethacrylate, 1,3-butylene diol dimethacrylate, or ethoxylated bisphenol A dimethacrylate. The multifunctional methacrylate may, for example, be trimethylolpropane trimethacrylate.

Such radical polymerizable compounds may be used alone or in combination of two or more.

### (Polymerizable Resin)

The photoradical polymerizable composition of the present invention may further contain a polymerizable resin. The polymerizable resin may be a binder polymer such as a photopolymerizable prepolymer, an acrylic resin, a styrene resin or an epoxy resin, or an alkali-soluble resin.

The photopolymerizable prepolymer is not particularly limited and may, for example, be polyester acrylate, polyester methacrylate, epoxy acrylate, epoxy methacrylate, polyurethane acrylate or polyurethane methacrylate. Such photopolymerizable prepolymers may be used alone or in combination of two or more. Among such photopolymerizable prepolymers, preferred are polyurethane acrylate and polyurethane methacrylate.

As the alkali-soluble resin, a compound having a hydroxy group and/or a carboxy group and an ethylenically unsaturated bond is preferably used. A compound having a group to form a hydroxy group during the reaction and an ethylenically unsaturated bond, such as an epoxy compound, may also be used.

The compound having a hydroxy group and an ethylenically unsaturated bond may, for example, be 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, 2-hydroxy-3-phenoxypropyl acrylate, 2-acryloyloxyethyl-2-hydroxyethyl phthalate, glycerol mono(meth)acrylate, dihydroxy acrylate, glycerol (meth)acrylate, pentaerythritol mono(meth)acrylate, or dipentaerythritol mono(meth)acrylate. Further, 2-hydroxy 3-acryloyloxypropyl methacrylate, pentaerythritol di(meth)acrylate, dipentaerythritol di(meth)acrylate, pentaerythritol diacrylate, isocyanuric acid EO-modified diacrylate, pentaerythritol tri(meth)acrylate, dipentaerythritol tri(meth)acrylate, dipentaerythritol tetra(meth)acrylate, and dipentaerythritol penta(meth)acrylate may, for example, be mentioned. A glycidyl (meth) acrylate which forms a hydroxy group by reaction may also be mentioned. However, the compound is not limited thereto.

The compound having a carboxy group and an ethylenically unsaturated bond may, for example, be acrylic acid, methacrylic acid, 2-acryloyloxyethyl succinate, crotonic acid, isocrotonic acid, tiglic acid, 3-methyl crotonate, 2-methyl 2-pentenoate, α-hydroxyacrylic acid, α-chloroacrylic acid or cinnamic acid. Further, maleic acid, fumaric acid, itaconic acid, citraconic acid and mesaconic acid may, for example, be mentioned. Further, mono(2-acryloyloxyethyl) succinate, mono(2-methacryloyloxyethyl) succinate, mono(2-acryloyloxyethyl) phthalate and mono(2-methacryloyloxyethyl) phthalate may, for example be mentioned. Further, for example, ω-carboxypolycaprolactone monoacrylate and ω-carboxypolycaprolactone monomethacrylate may also be mentioned.

As the alkali-soluble resin, not only a monomer but also an oligomerized alkali-soluble resin may be used. As the oligomerized alkali-soluble resin, one commonly used for negative resists may be used, and it is not particularly limited so long as it is soluble in an aqueous alkali solution. It may, for example, be a copolymer of at least one member selected from methyl (meth)acrylate, ethyl (meth)acrylate, n-propyl (meth)acrylate, isopropyl (meth)acrylate, n-butyl (meth)acrylate, sec-butyl (meth)acrylate, isobutyl (meth)acrylate, tert-butyl (meth)acrylate, n-pentyl (meth)acrylate, n-hexyl (meth)acrylate, 2-ethylhexyl (meth)acrylate, n-octyl (meth)acrylate, n-decyl (meth)acrylate, benzyl (meth)acrylate, styrene, γ-methylstyrene, N-vinyl-2-pyrolidone and glycidyl (meth)acrylate and the like, and at least one member selected from (meth)acrylic acid, itaconic acid, crotonic acid, maleic acid, fumaric acid, vinyl acetate, and anhydrides thereof; or a polymer obtained by adding an ethylenically unsaturated compound having a glycidyl group or a hydroxy group to the above copolymer. Further, a carboxy group-containing resin obtained by copolymerization of an unsaturated carboxylic acid such as (meth)acrylic acid with an unsaturated group-containing compound such as styrene, α-methylstyrene, a lower alkyl (meth)acrylate or isobutylene; a carboxy group-containing urethane resin formed by addition polymerization reaction of a diisocyanate such as an aliphatic diisocyanate, a branched aliphatic diisocyanate, an alicyclic diisocyanate or an aromatic diisocyanate, with a diol compound such as a carboxy group-containing dialcohol compound such as dimethylolpropionic acid or dimethylolbutanoic acid, polycarbonate-based polyol, polyether-based polyol, polyester-based polyol, polyolefin-based polyol, acrylic polyol, bisphenol A alkylene oxide adduct diol or a compound having a phenolic hydroxy group and an alcoholic hydroxy group; a terminal carboxy group-containing urethane resin obtained by reacting an acid anhydride to a terminal of a urethane resin formed by addition polymerization reaction of a diisocyanate compound such as an aliphatic diisocyanate, a branched aliphatic diisocyanate, an alicyclic diisocyanate or an aromatic diisocyanate, with a diol compound such as polycarbonate-based polyol, polyether-based polyol, polyester-based polyol, polyolefin-based polyol, acrylic polyol, bisphenol A alkylene oxide adduct diol or a compound having a phenolic hydroxy group and an alcoholic hydroxy group; a carboxy group-containing urethane resin obtained by addition polymerization reaction of a diisocyanate with a (meth)acrylate of a bifunctional epoxy resin or a partially anhydride modified product such as bisphenol A epoxy resin, hydrogenated bisphenol A epoxy resin, bisphenol F epoxy resin, bisphenol S epoxy resin, bixylenol epoxy resin, bisphenol epoxy resin, a carboxy group-containing dialcohol compound or a diol compound; and a carboxy group-containing urethane resin having its terminal (meth)acrylated obtained by adding a compound having one hydroxy group and one or more (meth)acryloyl group to a molecule of e.g. hydroxyalkyl (meth)acrylate may also be mentioned. As commercial products of alkali-soluble resins, Dianal NR series (manufactured by Mitsubishi Rayon Co., Ltd.), Viscoat R-264, KS resist 106 (manufactured by OSAKA ORGANIC CHEMICAL INDUSTRY LTD.), Ebecryl 3800 (manufactured by DAICEL-ALLNEX LTD.), ACRYCURE RD-F8 (manufactured by NIPPON SHOKUBAI CO., LTD.), PHORET ZAH-110 (manufactured by Soken Chemical & Engineering Co., Ltd.) may, for example, be mentioned.

Further, to the photoradical polymerizable composition of the present invention, within a range not to impair the effects of the present invention, for the purpose of accelerating radical polymerization, a hydrogen donor may be added. The hydrogen donor may, for example, be an alcohol type hydrogen donor such as methanol, ethanol, n-propanol, isopropanol, n-butyl alcohol, isobutyl alcohol, sec-butyl alcohol, 1,2,4-butanetriol, 1,2,6-hexanetriol, 1,2,3-heptanetriol, 2,6-dimethyl-1,2,6-hexanetriol, 1,2,3-hexanetriol, 1,2,3-butanetriol, 3-methyl-1,3,5-pentanetriol, 3,7,11,15-tetramethyl-1,2,3-hexadecanetriol, ethylene glycol, glycerin, propylene glycol, diethylene glycol, trimethylolpropane, trimethylolethane, pentaerythritol, dipentaerythritol, 1,4-hexanediol, 1,4-hexanedimethanol, trimethylolpropane, glycerin, hydroxyacetone, glycolic acid, acetoin, valeroin, methyl glycolate, butyl lactate or 3-hydroxy butyrate, a mercaptan-type hydrogen donor such as 2-mercaptobenzothiazole, 2-mercaptobenzoxazole, 2-mercaptobenzimidazole, 2,5-dimercapto-1,3,4-thiazole or 2-mercapto-2,5-dimethylaminopyridine. Further, it may be an amine-type hydrogen donor such as 4,4′-bis(dimethylamino)benzophenone, 4,4′-bis(diethylamino)benzophenone, 4-diethylaminoacetophenone, 4-dimethylaminopropiophenone, ethyl-4-dimethylaminobenzoate, 4-dimethylaminobenzoic acid or 4-dimethylaminobenzonitrile. Further, it may, for example, be bis [4-(dimethylamino)phenyl]methane, bis[4-(diethylamino)phenyl]methane or Leuco Crystal Violet. Such hydrogen donors may be used alone or in combination of two or more.

Further, to the photoradical polymerizable composition of the present invention, within a range not to impair the effects of the present invention, in addition to the above, resin additives such as a pigment and/or a dye, a diluting agent, a dispersing agent, an organic or inorganic filler, a leveling agent, a surfactant, a defoaming agent, a thickener, a flame retardant, a surface modifier, a penetration enhancing agent, a humectant, an adhesion promoter, a fungicide, a preservative, an antioxidant, a polymerization inhibitor, an ultraviolet absorber, a photo stabilizer, a chelating agent, a pH modifier, a stabilizer, a lubricant and a plasticizer may be blended. Depending upon application, the composition may contain a solvent.

### [Pigment]

As the pigment which may be used in the present invention, the following may be mentioned (represented by Colour Index Number). C.I. Pigment Yellow 12, 13, 14, 17, 20, 24, 55, 83, 86, 93, 109, 110, 117, 125, 137, 139, 147, 148, 153, 154, 166, 168, C.I. Pigment Orange 36, 43, 51, 55, 59, 61, C.I. Pigment Red 9, 97, 122, 123, 149, 168, 177, 180, 192, 215, 216, 217, 220, 223, 224, 226, 227, 228, 240, C.I. Pigment Violet 19, 23, 29, 30, 37, 40, 50, C.I. Pigment Blue 15, 15:1, 15:4, 15:6, 22, 60, 64, C.I. Pigment Green 7, 36, C.I. Pigment Brown 23, 25, 26, etc.

Further, as a black pigment, carbon black and titanium black may, for example, be mentioned, and as specific examples of carbon black, Special Black 4, Special Black 100, Special Black 250, Special Black 350, Special Black 550 manufactured by Deggusa; Raven 1040, Raven 1060, Raven 1080, Raven 1255 manufactured by Columbia Carbon; MA7, MA8, MA11, MA100, MA220, MA230 manufactured by Mitsubishi Chemical Corporation may, for example, be mentioned.

### [Solvent]

To the photopolymerizable composition of the present invention, to impart coating applicability, a solvent may be added to adjust the viscosity. The solvent may, for example, be methanol, ethanol, toluene, cyclohexane, isophorone, cellosolve acetate, diethylene glycol dimethyl ether, ethylene glycol diethyl ether, xylene, ethylbenzene, methyl cellosolve, ethyl cellosolve, butyl cellosolve, propylene glycol monomethyl ether, propylene glycol monomethyl ether acetate, diethylene glycol diethyl ether acetate, isoamyl acetate, ethyl lactate, methyl ethyl ketone, acetone or cyclohexanone. They may be used alone or in combination of two or more.

### (Photopolymerization Method)

The photoradical polymerizable composition of the present invention is irradiated with light and polymerized to obtain a polymerized product. In a case where the photoradical polymerizable composition is irradiated with light and cured, the photoradical polymerizable composition may be formed into a film and photopolymerized, or may be formed into a block and photopolymerized. In a case where the composition is formed into a film and photopolymerized, the photoradical polymerizable composition in a liquid state is applied, for example, to a substrate such as a polyester film by means of a bar coater into a film thickness of from 5 μm to 300 μm.

As the substrate used, a film, paper, an aluminum foil, a metal, wood, a plastic substrate, etc. are mainly used, but the substrate is not particularly limited. As a material used for a film as the substrate, a film or sheet of e.g. polyvinyl chloride, polyethylene terephthalate (PET), polycarbonate (PC), polystyrene (PS), polyurethane (PU), polyethylene (PE) or polypropylene (PP) may, for example, be used. A film or sheet of e.g. an ethylene/vinyl acetate copolymer, an ethylene/vinyl alcohol copolymer, an ethylene/methacrylic acid copolymer, nylon, polylactic acid or polycarbonate, cellophane, an aluminum foil, or a composite material thereof may also be mentioned. Paper such as woodfree paper, coated paper, art paper, simili paper, thin paper or boxboard, or a laminate of synthetic paper and a film may also be useful. Particularly, a plastic film of e.g. PE or PP is preferred.

A method of applying the photoradical polymerizable composition of the present invention to a substrate film is not particularly limited, and for example, a bar coater, a roll coater, a gravure coater, a flexographic coater, an air doctor coater, a blade coater, an air knife coater, a squeeze coater, a dip coater, a transfer roll coater, a kiss coater, a curtain coater, a cast coater, a spray coater, a die coater, a spin coater, an offset printing machine, a screen printing machine, etc. may properly be employed. An application method of spraying droplets of the composition by an inkjet machine on the substrate may also be employed. Since the photoradical polymerizable composition of the present invention can be cured at a sufficient speed, it can be cured simultaneously with application, and a cured film can be formed without a complicated apparatus or complicated process. Further, it is possible to apply e.g. heat treatment after curing.

A coating film formed of the photoradical polymerizable composition thus prepared, is irradiated with energy rays at an illuminance of from about 1 to about 1,000 mW/cm² to obtain a photopolymerized product. The light source used may, for example, be a high pressure mercury lamp, an ultra-high pressure mercury lamp, a metal halide lamp, a xenon lamp, a gallium-doped lamp, a black light, ultraviolet LED with a center wavelength of 365 nm, 375 nm, 385 nm, 395 nm or 405 nm, blue LED, white LED, or D bulb or V bulb manufactured by Heraeus. Natural light such as sunlight may also be used. Since the photoradical polymerization initiator of the present invention has ultraviolet absorption at from 350 nm to 420 nm and has a capacity to generate radical species by light in such a wavelength range, an irradiation source which emits light having a wavelength within a range of from 350 nm to 420 nm is preferred, and in that viewpoint, an ultraviolet LED with a center wavelength of 365 nm, 375 nm, 385 nm, 395 nm or 405 nm, or a semiconductor laser is preferred.

### (Photo Rheometer)

In Examples, the photo-curing property was evaluated by photo rheometer measurement as follows. Using as a UV irradiation apparatus, a photo-rheometer MCR102 (manufactured by Anton Paar) having a UV irradiation apparatus (manufactured by HAMAMATSU PHOTONICS K.K., LIGHTNINGCURE) attached, changes of the complex viscosity of the photoradical polymerizable composition were measured, and from the obtained viscosity increasing rate, the curing rate was determined.

Photo-rheometer: manufactured by Anton Paar, Modular Compact Rheometer MCR102

Measurement jig: parallel plates (diameter: 10 mm)

Thickness: 10 μm

Amplitude: constant at 5.0%

Frequency: constant at 10 Hz

Temperature: constant at 30° C.

Measurement atmosphere: nitrogen atmosphere

UV irradiation apparatus: LIGHTNINGCURE (high pressure mercury-xenon lamp) manufactured by HAMAMATSU PHOTONICS K.K., 405 nm band-pass filter

Illuminance: 50 mW/cm²

Irradiation initiation time: 30 seconds later

Irradiation time: 300 seconds

Curing time: The complex viscosity was measured from the start of light irradiation and plotted on a graph based on the time in the horizontal axis, and the time (second) at which the complex viscosity reached 6,000 Pas was taken as the curing time.

The number average molecular weight (Mn) and the weight average molecular weight (Mw) were measured by means of gel permeation chromatography, and calculated as standard polystyrene.

GPC: measured by the following apparatus constitution under the following conditions.

2000 series manufactured by JASCO Corporation

Intelligent RI Detector RI-2031 Plus (JASCO)

Intelligent HPLC Pump PU-2080 Plus (JASCO)

Intelligent Sampler AS-2055 Plus (JASCO)

Intelligent Column Oven CO-2065

GPC column: two columns GPCKF-806L (Shodex) in series

Flow rate: 1 ml/min

Oven temperature: 40° C.

Carrier: tetrahydrofuran (THF)

### Photo-Curing Property (Photo-DSC)

In Examples, photo-curing property was evaluated also by measuring the total heating value by Photo-DSC. Specifically, in Photo-DSC measurement, the total heating value in 5 minutes from the start of light irradiation per 1.00 mg of the sample was obtained. The Photo-DSC measurement conditions are as follows.

Photo-DSC apparatus: differential thermal analyzer X-DSC700 manufactured by Hitachi High-Tech Science Corporation

UV irradiation apparatus: 405 nm LED lighting box (LLBK1) manufactured by AITEC SYSTEM Co., Ltd.

Illuminant: 50 mW/cm²

Irradiation time: 300 seconds

Measurement atmosphere: stream of air at 100 ml/min

Sample amount: 1 mg

Sample thickness: about 300 μm

### EXAMPLES

Now, the present invention will be described in further detail with reference to Examples. However, Examples are merely exemplified as Examples. That is, the following Examples are not exhaustive nor intended to restrict the present invention as described. Accordingly, the present invention is by no means restricted to the following Examples within a range not to exceed the scope of the present invention. Further, unless otherwise specified, all the parts and percentages are based on the weight.

### Photoradical Polymerization Curing Rate

### Example 1

To 100 parts of trimethylolpropane triacrylate as a radical polymerizable compound, 1 part of phenyl 1,4-dihydroxy-2-naphthoate as a photoradical polymerization initiator was added and stirred for dissolution to obtain a liquid photoradical polymerizable composition. The photoradical polymerizable composition was applied between parallel plates so that the film thickness would be 10 μm to a photo-rheometer MCR102 (manufactured by Anton Paar) having a UV irradiation apparatus (manufactured by HAMAMATSU PHOTONICS K.K., LIGHTNINGCURE) attached, and irradiated with ultraviolet rays at an illuminance of 50 mW/cm² through a 405 nm band-pass filter, for 300 seconds from 30 seconds after the start of measurement, and changes of the complex viscosity of the photoradical polymerizable composition were measured. The time (second) at which the complex viscosity reached 6,000 Pas after the start of irradiation was taken as the curing time and shown in Table 1.

### Example 2

In the same manner as in Example 1 except that 0.5 parts of phenyl 1,4-dihydroxy-2-naphthoate was used as the photoradical polymerization initiator, a photoradical polymerizable composition was prepared, which was irradiated with ultraviolet rays in the same manner, changes of the complex viscosity of the photoradical polymerizable composition were measured by the photo-rheometer, and the time (second) at which the complex viscosity reached 6,000 Pas was taken as the curing time and is shown in Table 1.

### Example 3

In the same manner as in Example 1 except that 0.2 parts of phenyl 1,4-dihydroxy-2-naphthoate was used as the photoradical polymerization initiator, a photoradical polymerizable composition was prepared, which was irradiated with ultraviolet rays in the same manner, changes of the complex viscosity of the photoradical polymerizable composition were measured by the photo-rheometer, and the time (second) at which the complex viscosity reached 6,000 Pas was taken as the curing time and is shown in Table 1.

### Example 4

In the same manner as in Example 1 except that 1,4-dihydroxy-2-naphthoic acid was used instead of phenyl 1,4-dihydroxy-2-naphthoate as the photoradical polymerization initiator, a photoradical polymerizable composition was prepared, which was irradiated with ultraviolet rays in the same manner, changes of the complex viscosity of the photoradical polymerizable composition were measured by the photo-rheometer, and the time (second) at which the complex viscosity reached 6,000 Pas was taken as the curing time and is shown in Table 1.

### Comparative Example 1

In the same manner as in Example 1 except that methyl 1,4-dimethoxy-2-naphthoate was used instead of phenyl 1,4-dihydroxy-2-naphthoate as the photoradical polymerization initiator, a photoradical polymerizable composition was prepared, which was irradiated with ultraviolet rays in the same manner, changes of the complex viscosity of the photoradical polymerizable composition were measured by the photo-rheometer, and the time (second) at which the complex viscosity reached 6,000 Pas was taken as the curing time and is shown in Table 1.

### Comparative Example 2

In the same manner as in Example 1 except that 1,4-dimethoxy-2-naphthoic acid was used instead of phenyl 1,4-dihydroxy-2-naphthoate as the photoradical polymerization initiator, a photoradical polymerizable composition was prepared, which was irradiated with ultraviolet rays in the same manner, changes of the complex viscosity of the photoradical polymerizable composition were measured by the photo-rheometer, and the time (second) at which the complex viscosity reached 6,000 Pas was taken as the curing time and is shown in Table 1.

### Comparative Example 3

In the same manner as in Example 1 except that 1-hydroxycyclohexyl phenyl ketone was used instead of phenyl 1,4-dihydroxy-2-naphthoate as the photoradical polymerization initiator, a photoradical polymerizable composition was prepared, which was irradiated with ultraviolet rays in the same manner, changes of the complex viscosity of the photoradical polymerizable composition were measured by the photo-rheometer, and the time (second) at which the complex viscosity reached 6,000 Pas was taken as the curing time and is shown in Table 1.

### Comparative Example 4

In the same manner as in Example 1 except that 2-methyl-1-[4-(methylthio)phenyl]-2-morpholinopropan-1-one was used instead of phenyl 1,4-dihydroxy-2-naphthoate as the photoradical polymerization initiator, a photoradical polymerizable composition was prepared, which was irradiated with ultraviolet rays in the same manner, changes of the complex viscosity of the photoradical polymerizable composition were measured by the photo-rheometer, and the time (second) at which the complex viscosity reached 6,000 Pas was taken as the curing time and is shown in Table 1.

### Comparative Example 5

In the same manner as in Example 1 except that 2-isopropylthioxanthone was used instead of phenyl 1,4-dihydroxy-2-naphthoate as the photoradical polymerization initiator, a photoradical polymerizable composition was prepared, which was irradiated with ultraviolet rays in the same manner, changes of the complex viscosity of the photoradical polymerizable composition were measured by the photo-rheometer, and the time (second) at which the complex viscosity reached 6,000 Pas was taken as the curing time and is shown in Table 1.

The results in Examples 1 to 4 and Comparative Examples 1 to 5 are shown in Table 1.

TABLE 1

| | Radical polymerizable | | | | | |
|---|---|---|---|---|---|---|
| | compound | | Photoradical polymerization initiator | | | |
| | | Amount | | Amount | Light | |
| | | used | | used | source | Curing |
| | | (parts by | | (parts by | wavelength | time |
| | Compound | weight) | Compound | weight) | (nm) | (sec) |
| Ex. 1 | Trimethylolpropane | 100 | Phenyl | 1.0 | 405 | 5.5 |
| Ex. 2 | triacrylate | | 1,4-dihydroxy-2-naphthoate | 0.5 | | 10.9 |
| Ex. 3 | | | | 0.2 | | 17.3 |
| Ex. 4 | | | 1,4-Dihydroxy-2-naphthoic acid | 1.0 | | 26.7 |
| Comp. | | | Methyl | 1.0 | | 200< |
| Ex. 1 | | | 1,4-dimethoxy-2-naphthoate | | | |
| Comp. | | | 1,4-Dimethoxy-2-naphthoic acid | 1.0 | | 200< |
| Ex. 2 | | | | | | |
| Comp. | | | 1-Hydroxycyclohexyl phenyl | 1.0 | | 129.0 |
| Ex. 3 | | | ketone | | | |
| Comp. | | | 2-Methyl-1-[4-(methylthio) | 1.0 | | 10.3 |
| Ex. 4 | | | phenyl]-2-morpholinopropan-1-one | | | |
| Comp. | | | 2-Isopropylthioxanthone | 1.0 | | 7.8 |
| Ex. 5 | | | | | | |

It is found from comparison between Examples 1 to 4 and Comparative Examples 1 and 2 that in photoradical polymerization reaction of the radical polymerizable compound (trimethylolpropane triacrylate) by irradiation with light having a wavelength of 405 nm, the 1,4-dihydroxy-2-naphthoic acid compound of the present invention was cured within 30 seconds, whereas the 1,4-dimethoxy-2-naphthoic acid compound having an analogous structure was not cured even after 200 seconds. That is, it is found that the 1,4-dihydroxy structure is important for development of the function as a photoradical polymerization initiator.

Further, in Example 1 in which phenyl 1,4-dihydroxy-2-naphthoate was used as the photoradical polymerization initiator, the curing time which is the time at which the complex viscosity reached 6,000 Pas was 5.5 seconds, thus indicating that the composition was cured in a very short time. This value of the curing time of 5.5 seconds is shorter than the curing time of 2-methyl-1-[4-(methylthio)phenyl]-2-morpholinopropan-1-one (OMNIRAD 907) (Comparative Example 4; 10.3 seconds) and the curing time of 2-isopropylthioxanthone (ITX) (Comparative Example 5; 7.8 seconds), which are commercially available photoradical polymerization initiators having high activity at the above wavelength, and it is thereby found that phenyl 1,4-dihydroxy-2-naphthoate is very excellent as the photoradical polymerization initiator. And, phenyl 1,4-dihydroxy-2-naphthoate is a very environmentally friendly compound composed solely of carbon atoms, oxygen atoms and hydrogen atoms, containing no sulfur or nitrogen atom, as different from OMNIRAD 907 and ITX.

### Example 5

To 100 parts of trimethylolpropane triacrylate as a radical polymerizable compound, phenyl 1,4-dihydroxy-2-naphthoate as a photoradical polymerization initiator was added in an amount of 0.02 mmol (corresponding to 0.2 to 0.3 parts), and several drops of MEGAFACE F-556 (manufactured by DIC Corporation) as a surfactant/surface modifier were added and stirred for dissolution to obtain a liquid photoradical polymerizable composition. The photoradical polymerizable composition was applied to an aluminum plate so that the film thickness would be 4 μm by a roller bar (Select-Roller L60 OSP-04 manufactured by Matsuo Sangyo Co., Ltd.) in FT-IR Nicolet iS50 manufactured by ThermoFisher Scientific, having a UV irradiation apparatus (405 nm LED lighting box (LLBK1), manufactured by AITEC SYSTEM Co., Ltd.) attached, the interior of the sample chamber was replaced with nitrogen, and the composition was irradiated with light at an illuminance of 50 mW/cm² for 105 seconds from 15 seconds after the start of measurement. In accordance with the absorption intensity at the peak of vibration of the C═C bond in (meth)acrylic acid ester in the vicinity of 810 cm¹ of the photoradical polymerizable composition, the curing rate was calculated based on the curing rate at the absorption intensity before irradiation with light as 0%, and the curing rate when the absorption intensity became 0 as 100%. The time (second) at which the monomer curing rate reached 20% after the start of light irradiation was taken as the curing time, and the results are shown in Table 2.

### Example 6

In the same manner as in Example 5 except that phenyl 1,4-dihydroxy-2-naphthoate was changed to 1,4-dihydroxy-2-naphthoic acid, a photoradical polymerizable composition was prepared, which was irradiated with light under the same conditions, and the time (second) at which the monomer curing rate reached 20% was measured and shown in Table 2.

### Example 7

In the same manner as in Example 5 except that phenyl 1,4-dihydroxy-2-naphthoate was changed to methyl 1,4-dihydroxy-2-naphthoate, a photoradical polymerizable composition was prepared, which was irradiated with light under the same conditions, and the time (second) at which the monomer curing rate reached 20% was measured and shown in Table 2.

### Example 8

In the same manner as in Example 5 except that phenyl 1,4-dihydroxy-2-naphthoate was changed to ethyl 1,4-dihydroxy-2-naphthoate, a photoradical polymerizable composition was prepared, which was irradiated with light under the same conditions, and the time (second) at which the monomer curing rate reached 20% was measured and shown in Table 2.

### Comparative Example 6

In the same manner as in Example 5 except that no phenyl 1,4-dihydroxy-2-naphthoate was added, a photoradical polymerizable composition was prepared, which was irradiated with light under the same conditions, and the time (second) at which the monomer curing rate reached 20% was measured and shown in Table 2.

TABLE 2

| | Radical polymerizable | | | | | |
|---|---|---|---|---|---|---|
| | compound | | Photoradical polymerization initiator | | | Time at which |
| | | Amount | | Amount | Light | monomer |
| | | used | | used | source | curing rate |
| | | (parts by | | (parts by | wavelength | reached 20% |
| | Compound | weight) | Compound | weight) | (nm) | (sec) |
| Ex. 5 | Trimethylolpropane | 100 | Phenyl | 0.28 | 405 | 18.5 |
| | triacrylate | | 1,4-dihydroxy-2-naphthoate | | | |
| Ex. 6 | | | 1,4-Dihydroxy-2-naphthoic | 0.20 | | 23.4 |
| | | | acid | | | |
| Ex. 7 | | | Methyl | 0.22 | | 21.4 |
| | | | 1,4-dihydroxy-2-naphthoate | | | |
| Ex. 8 | | | Ethyl | 0.23 | | 25.2 |
| | | | 1,4-dihydroxy-2-naphthoate | | | |

| | | |
|---|---|---|
| Comp. | Nil | 115.0 |
| Ex. 6 | | |

It is found, also from the comparison between Examples 5 to 8 and Comparative Example 6, that various 1,4-dihydroxy-2-naphthoic acid compounds including 1,4-dihydroxy-2-naphthoic acid and various 1,4-dihydroxy-2-naphthoates have high capacity to initiate radical polymerization. Further, it is found that phenyl 1,4-dihydroxy-2-naphthoate has the highest effect.

### Radical Polymerization Inhibiting Capacity

### Example 10

To 100 parts of trimethylolpropane triacrylate, 0.5 parts of lauroyl peroxide as a heat radical initiator and 2 parts of phenyl 1,4-dihydroxy-2-naphthoate as a photoradical polymerization initiator were mixed to obtain a radical polymerizable composition. The radical polymerizable composition was applied between parallel plates so that the film thickness would be 10 μm to a photo-rheometer MCR102 (manufactured by Anton Paar) and kept in a nitrogen atmosphere at 60° C. without light irradiation, the time (second) at which the complex viscosity reached 100 Pas was taken as the induction period (IP), and the state of the radical polymerizable composition 5,000 seconds later was observed. The results are shown in Table 3.

### Example 11

In the same manner as in Example 10 except that 1,4-dihydroxy-2-naphthoic acid was used instead of phenyl 1,4-dihydroxy-2-naphthoate as the photoradical polymerization initiator, a photoradical polymerizable composition was prepared, and in the same manner, the time (second) at which the complex viscosity reached 100 Pas was taken as the induction period (IP), and the state of the radical polymerizable composition 5,000 seconds later was observed. The results are shown in Table 3.

### Comparative Example 32

To 100 parts of trimethylolpropane triacrylate, 0.5 parts of lauroyl peroxide as a heat radical initiator was mixed to obtain a radical polymerizable composition. The radical polymerizable composition was applied between parallel plates so that the film thickness would be 10 μm to a photo-rheometer MCR102 (manufactured by Anton Paar) and kept in a nitrogen atmosphere at 60° C. without light irradiation, the time (second) at which the complex viscosity reached 100 Pas was taken as the induction period (IP), and the state of the radical polymerizable composition 5,000 seconds later was observed. The results are shown in Table 3.

### Comparative Example 7

In the same manner as in Example 10 except that 1-hydroxy-4-ethoxy-2-naphthoic acid was used instead of phenyl 1,4-dihydroxy-2-naphthoate as the photoradical polymerization initiator, a photoradical polymerizable composition was prepared, and in the same manner, the time (second) at which the complex viscosity reached 100 Pas was taken as the induction period (IP), and the state of the radical polymerizable composition 5,000 seconds later was observed. The results are shown in Table 3.

### Comparative Example 29

In the same manner as in Example 10 except that 1,4-dimethoxy-2-naphthoic acid was used instead of phenyl 1,4-dihydroxy-2-naphthoate as the photoradical polymerization initiator, a photoradical polymerizable composition was prepared, and in the same manner, the time (second) at which the complex viscosity reached 100 Pas was taken as the induction period (IP), and the state of the radical polymerizable composition 5,000 seconds later was observed. The results are shown in Table 3.

### Comparative Example 30

In the same manner as in Example 10 except that methyl 1,4-dimethoxy-2-naphthoate was used instead of phenyl 1,4-dihydroxy-2-naphthoate as the photoradical polymerization initiator, a photoradical polymerizable composition was prepared, and in the same manner, the time (second) at which the complex viscosity reached 100 Pas was taken as the induction period (IP), and the state of the radical polymerizable composition 5,000 seconds later was observed. The results are shown in Table 3.

### Comparative Example 8

In the same manner as in Example 10 except that OMNIRAD TPO (2,4,6-trimethylbenzoyl-diphenyl phosphine oxide) was used instead of phenyl 1,4-dihydroxy-2-naphthoate as the photoradical polymerization initiator, a photoradical polymerizable composition was prepared, and in the same manner, the time (second) at which the complex viscosity reached 100 Pas was taken as the induction period (IP), and the state of the radical polymerizable composition 5,000 seconds later was observed. The results are shown in Table 3.

### Comparative Example 31

In the same manner as in Example 10 except that OMNIRAD 184 (1-hydroxycyclohexyl phenyl ketone) was used instead of phenyl 1,4-dihydroxy-2-naphthoate as the photoradical polymerization initiator, a photoradical polymerizable composition was prepared, and in the same manner, the time (second) at which the complex viscosity reached 100 Pas was taken as the induction period (IP), and the state of the radical polymerizable composition 5,000 seconds later was observed. The results are shown in Table 3.

TABLE 3

| | Radical | | Heat radical | | Photoradical | | | | | |
|---|---|---|---|---|---|---|---|---|---|---|
| | polymerizable | | polymerization | | polymerization | | | | | |
| | compound | | initiator | | initiator | | | | State of | |
| | | Amount | | Amount | | Amount | | | radical | Polymerization |
| | | used | | used | | used | | | polymerizable | inhibiting effect |
| | | (parts | | (parts | | (parts | | Light | composition | of photoradical |
| | | by | | by | | by | Heating | irradiation | after | polymerization |
| | Compound | weight) | Compound | weight) | Compound | weight) | (60° C.) | (405 nm) | measurement | initiator |
| Ex. 10 | Trimethylol- | 100 | Lauroyl | 0.5 | DHNAPh | 2 | Conducted | Nil | Liquid | Observed |
| Ex. 11 | propane | | peroxide | | DHNA | 2 | | | Liquid | Observed |
| Comp. | triacrylate | | | | Nil | | | | Solid | Nil |
| Ex. 32 | | | | | | | | | | |
| Comp. | | | | | 1H4EtNA | 2 | | | Solid | Nil |
| Ex. 7 | | | | | | | | | | |
| Comp. | | | | | DMeNA | 2 | | | Solid | Nil |
| Ex. 29 | | | | | | | | | | |
| Comp. | | | | | DMeNAMe | 2 | | | Solid | Nil |
| Ex. 30 | | | | | | | | | | |
| Comp. | | | | | TPO | 2 | | | Solid | Nil |
| Ex. 8 | | | | | | | | | | |
| Comp. | | | | | 184 | 2 | | | Solid | Nil |
| Ex. 31 | | | | | | | | | | |

DHNAPh: phenyl 1,4-dihydroxy-2-naphthoate
DHNA: 1,4-dihydroxy-2-naphthoic acid
1H4EtNA: 1-hydroxy-4-ethoxy-2-naphthoic acid
DMeNA: 1,4-dimethoxy-2-naphthoic acid
DMeNAMe: methyl 1,4-dimethoxy-2-naphthoate
TPO: OMNIRAD TPO; 2,4,6-trimethylbenzoyl-diphenyl phosphine oxide
184: OMNI RAD 184; 1-hydroxycyclohexyl phenyl ketone

Examples 10 and 11 and Comparative Examples 29 to 32, 7 and 8 are examples in which the composition was heated to 60° C. under conditions without light irradiation that is under dark conditions to try heat polymerization. As evident from Comparative Example 32 that trimethylolpropane triacrylate was polymerized and cured to form a solid under heating at 60° C., by lauroyl peroxide as a heat radical polymerization initiator. Whereas in Examples 10 and 11, by coexistence of 1,4-dihydroxy-2-naphthoic acid compound, the composition was not polymerized and stayed in a liquid state, and thus it is found that polymerization by the heat radical polymerization initiator was inhibited. This polymerization inhibition is caused by such a mechanism that radical species generated by the heat radical polymerization initiator are scavenged by the 1,4-dihydroxy-2-naphthoic acid compound, whereby radical polymerization is inhibited. It is found that the 1,4-dihydroxy-2-naphthoic acid compound has a capacity to scavenge radicals under conditions without light irradiation, that is under dark conditions.

On the other hand, as evident from Comparative Examples 7, 29 and 30, since the composition was cured within 5,000 seconds, with 1-hydroxy-4-ethoxy-2-naphthoic acid, 1,4-dimethoxy-2-naphthoic acid or methyl 1,4-dimethoxy-2-naphthoate, having a structure analogous to that of the 1,4-dihydroxy-2-naphthoic acid compound of the present invention, such initiators have no radical inhibiting effect as shown in the 1,4-dihydroxy-2-naphthoic acid compound. Further, as evident from Comparative Examples 8 and 31, since the composition was cured within 5,000 seconds with OMNIRAD TPO and 184 which are known photoradical polymerization initiators, such initiators have no radical scavenging capacity, and polymerization by the heat radical polymerization initiator occurs. It is found from these results that the 1,4-dihydroxy-2-naphthoic acid compound of the present invention has a capacity to scavenge radicals generated under dark conditions, this capacity is specific to the 1,4-dihydroxy-2-naphthoic acid compound and is not observed in 1-hydroxy-4-ethoxy-2-naphthoic acid and 1,4-dimethoxy-2-naphthoic acid compounds having an analogous structure, and thus the 1,4-dihydroxy structure has an important role to exhibit radical inhibiting capacity. Since no radical inhibiting capacity is observed in OMNIRAD TPO and 184 which are known photoradical polymerization initiators, the capacity is considered to be an effect specific to the 1,4-dihydroxy-2-naphthoic acid compound as the photoradical polymerization initiator of the present invention.

### Release of Radical Polymerization Inhibiting Capacity

### Example 13

To 100 parts of trimethylolpropane triacrylate, 0.5 parts of lauroyl peroxide as a heat radical initiator and 2 parts of phenyl 1,4-dihydroxy-2-naphthoate as a photoradical polymerization initiator were mixed to prepare a radical polymerizable composition. The radical polymerizable composition was applied between parallel plates so that the film thickness would be 10 μm to a photo-rheometer MCR102 (manufactured by Anton Paar) having a UV irradiation apparatus (manufactured by HAMAMATSU PHOTONICS K.K., LIGHTNINGCURE) attached, and irradiated with ultraviolet rays at an illuminance of 10 mW/cm² through a 405 nm band-pass filter in nitrogen atmosphere at 60° C. The time (second) at which the complex viscosity reached 100 Pas from the start of irradiation was taken as the induction period (IP), and the state of the radical polymerizable composition 5,000 seconds later was observed, and the results are shown in Table 4.

### Example 14

In the same manner as in Example 13 except that 1,4-dihydroxy-2-naphthoic acid was used instead of phenyl 1,4-dihydroxy-2-naphthoate as the photoradical polymerization initiator, a photoradical polymerizable composition was prepared, and in the same manner, the time (second) at which the complex viscosity reached 100 Pas was taken as the induction period (IP), and the state of the radical polymerizable composition 5,000 seconds later was observed. The results are shown in Table 4.

### Comparative Example 33

To 100 parts of trimethylolpropane triacrylate, 0.5 parts of lauroyl peroxide as a heat radical initiator was mixed to prepare a radical polymerizable composition. The radical polymerizable composition was applied between parallel plates so that the film thickness would be 10 μm to a photo-rheometer MCR102 (manufactured by Anton Paar) having a UV irradiation apparatus (manufactured by HAMAMATSU PHOTONICS K.K., LIGHTNINGCURE) attached, and irradiated with ultraviolet rays at an illuminance of 10 mW/cm² through a 405 nm band-pass filter in nitrogen atmosphere at 60° C. The time (second) at which the complex viscosity reached 100 Pas from the start of irradiation was taken as the induction period (IP), and the state of the radical polymerizable composition 5,000 seconds later was observed, and the results are shown in Table 4.

TABLE 4

| | Radical | | Heat radical | | Photoradical | | | | | |
|---|---|---|---|---|---|---|---|---|---|---|
| | polymerizable | | polymerization | | polymerization | | | | | |
| | compound | | initiator | | initiator | | | | | State of |
| | | Amount | | Amount | | Amount | | | Induction | radical |
| | | used | | used | | used | | | period | polymerizable |
| | | (parts | | (parts | | (parts | | Light | (time until | composition |
| | | by | | by | | by | Heating | irradiation | 100 Pas) | after |
| | Compound | weight) | Compound | weight) | Compound | weight) | (60° C.) | (405 nm) | (sec) | measurement |
| Ex. 13 | Trimethylol- | 100 | Lauroyl | 0.5 | DHNAPh | 2 | Conducted | 10 mW | 5 | Solid |
| Ex. 14 | propane | | peroxide | | DHNA | 2 | | | 5 | Solid |

| | | | | |
|---|---|---|---|---|
| Comp. | triacrylate | Nil | 960 | Solid |
| Ex. 33 | | | | |

DHNAPh: phenyl 1,4-dihydroxy-2-naphthoate
DHNA: 1,4-dihydroxy-2-naphthoic acid

Examples 13 and 14 and Comparative Example 33 are examples in which the composition was heated to 60° C. under irradiation with light of 405 nm, that is under light conditions to try polymerization by a heat radical polymerization initiator. As evident from Comparative Example 33 that trimethylolpropane triacrylate was polymerized and cured to form a solid by heating at 60° C. even under light conditions, by lauroyl peroxide as the heat radical polymerization initiator. Whereas as evident from comparison between Examples 10 and 11, and Examples 13 and 14, the radical polymerizable composition which did not undergo polymerization and remained in a liquid state even when the heat radical polymerization initiator was decomposed to generate radical species under dark conditions, promptly started polymerization under irradiation with light having a wavelength of 405 nm, that is under light conditions, and was cured and formed into a solid. Thus, it is found that the 1,4-dihydroxy-2-naphthoic acid compound of the present invention has a capacity to scavenge generated radicals to inhibit polymerization under dark conditions, whereas under light conditions, it loses the capacity to scavenge radicals and at the same time exhibits an effect to accelerate radical polymerization.

### Use in Combination with Other Photoradical Polymerization Initiator

### Example 15

To 100 parts of trimethylolpropane triacrylate as a radical polymerizable compound, 3 parts of 1-hydroxycyclohexyl phenyl ketone and 0.2 parts of phenyl 1,4-dihydroxy-2-naphthoate as photoradical polymerization initiators were added and stirred for dissolution to obtain a liquid photoradical polymerizable composition. The photoradical polymerizable composition was irradiated with ultraviolet rays at an illuminance of 50 mW/cm² by LIGHTNINGCURE (manufactured by HAMAMATSU PHOTONICS K.K., high pressure mercury-xenon lamp) through a 405 nm band-pass filter, and changes of the complex viscosity of the photoradical polymerizable composition were measured by a photo-rheometer. The time (second) at which the complex viscosity reached 6,000 Pas was taken as the curing time, and the results are shown in Tables 5 and 7.

### Example 16

In the same manner as in Example 15 except that 1,4-dihydroxy-2-naphthoic acid was used instead of phenyl 1,4-dihydroxy-2-naphthoate as the photoradical polymerization initiator, a photoradical polymerizable composition was prepared, which was irradiated with ultraviolet rays in the same manner, changes of the complex viscosity of the photoradical polymerizable composition were measured by the photo-rheometer, and the time (second) at which the complex viscosity reached 6,000 Pas was taken as the curing time and is shown in Table 5.

### Comparative Example 9

In the same manner as in Example 15 except that no phenyl 1,4-dihydroxy-2-naphthate as the photoradical polymerization initiator was added, a photoradical polymerizable composition was prepared, which was irradiated with ultraviolet rays in the same manner, changes of the complex viscosity of the photoradical polymerizable composition were measured by the photo-rheometer, and the time (second) at which the complex viscosity reached 6,000 Pas was taken as the curing time and is shown in Table 5.

TABLE 5

| | Radical polymerizable | | | | | | | |
|---|---|---|---|---|---|---|---|---|
| | compound | | Photoradical polymerization initiator | | | | | |
| | | Amount | | Amount | | Amount | | |
| | | used | | used | | used | Light | |
| | | (parts | | (parts | | (parts | source | Curing |
| | | by | | by | | by | Wavelength | (sec) |
| | Compound | weight) | Compound | weight) | Compound | weight) | (nm) | time |
| Ex. 15 | Trimethylolpropane | 100 | Phenyl | 0.2 | 1-Hydroxycyclohexyl | 3 | 405 | 12.0 |
| | triacrylate | | 1,4-dihydroxy-2-naphthoate | | phenyl ketone | | | |
| Ex. 16 | | | 1,4-Dihydroxy-2-naphthoic | | | | | 42.0 |
| | | | acid | | | | | |

| | | |
|---|---|---|
| Comp. | Nil | 79.0 |
| Ex. 9 | | |

Examples 15 and 16 are examples in which as the photoradical polymerization initiators, the 1,4-dihydroxy-2-naphthoic acid compound and 1-hydroxycyclohexyl phenyl ketone which is a general-purpose photoradical polymerization initiator were used in combination. As compared with a case (Comparative Examples 9) where 1-hydroxycyclohexyl phenyl ketone was used alone, the curing time was clearly shorter. Further, as evident from Example 3 in Table 1 and Example 15 in Table 5, as compared with Example 3 in which the curing time was 17.3 seconds when 0.2 parts of phenyl 1,4-dihydroxy-2-naphthoate was used alone as the photoradical polymerization initiator, in Example 15, the curing time was 12.0 seconds, that is it was shortened to about two thirds, by adding 3 parts of 1-hydroxycyclohexyl phenyl ketone having substantially no activity in the above wavelength range. That is, it is found from Example 15 that by using as the photoradical polymerization initiators phenyl 1,4-dihydroxy-2-naphthoate and 1-hydroxycyclohexyl phenyl ketone which is a general-purpose photoradical polymerization initiator are used in combination, an excellent effect is exhibited such that the curing time can remarkably be shortened by the synergistic effect.

### Example 17

To 100 parts of isobornyl acrylate which is a monofunctional acrylate as a radical polymerizable compound, 0.2 parts of phenyl 1,4-dihydroxy-2-naphthoate as a photoradical polymerization initiator was added and stirred for dissolution to obtain a liquid photoradical polymerizable composition. The photoradical polymerizable composition was applied between parallel plates so that the film thickness would be 1 mm to a photo-rheometer MCR102 (manufactured by Anton Paar) having a UV irradiation apparatus (manufactured by HAMAMATSU PHOTONICS K.K., LIGHTNINGCURE) attached, and irradiated with ultraviolet rays at an illuminance of 50 mW/cm² through a 405 nm band-pass filter for 25 minutes. The obtained cured product was left to stand in dark place further for 30 minutes, and then dissolved in THF, and the number average molecular weight and the weight average molecular weight of the polymer were measured by GPC. Further, the cured product left to sand in dark place was dipped in methanol for 24 hours, and the extract was subjected to measurement by HPLC to estimate the phenyl 1.4-dihydroxy-2-naphthoate remaining rate. The results are shown in Table 6.

### Example 18

In the same manner as in Example 17 except that 3 parts of 1-hydroxycyclohexyl phenyl ketone as the alkylphenone type photoradical polymerization initiator and 0.2 parts of phenyl 1,4-dihydroxy-2-naphthoate were used, a photoradical polymerizable composition was prepared, which was irradiated with ultraviolet rays for 25 minutes in the same manner and further left to stand in dark place for 30 minutes, then dissolved in THF, and the number average molecular weight and weight average molecular weight of the polymer were measured by GPC. Further, the cured product left to sand in dark place was dipped in methanol in an amount of about 100 times by weight for 24 hours at room temperature, and the extract was subjected to measurement by HPLC to estimate the phenyl 1,4-dihydroxy-2-naphthoate remaining rate. The results are shown in Table 6.

TABLE 6

| | Radical | | | | | | | | |
|---|---|---|---|---|---|---|---|---|---|
| | polymerizable | | | | | | | | |
| | compound | | Photoradical polymerization initiator | | | | | | |
| | | Amount | | Amount | | Amount | | | Phenyl |
| | | used | | used | | used | | | 1,4-dihydroxy- |
| | | (parts | | (parts | | (parts | | | 2-naphthoate |
| | | by | | by | | by | | | remaining |
| | Compound | weight) | Compound | weight) | Compound | weight) | Mn | Mw | rate (%) |
| Ex. | Isobornyl | 100 | Phenyl | 0.2 | Nil | | 246000 | 499000 | 21 |
| 17 | acrylate | | 1,4-dihydroxy-2- | | | | | | |
| Ex. | | | naphthoate | | 1-Hydroxycyclohexyl | 3 | 694000 | 1876000 | 0 |
| 18 | | | | | phenyl ketone | | | | |

It is found from comparison between Example 17 and Example 18 that also in a case where isobornyl acrylate which is a monofunctional acrylate is used as the radical polymerizable compound, phenyl 1,4-dihydroxy-2-naphthoate has a capacity to initiate radical polymerization. And, it is found from Table 6 that as compared with a case where phenyl 1,4-dihydroxy-2-naphthoate is used alone, by using 1-hydroxycyclohexyl phenyl ketone in combination, the number average molecular weight (Mn) is about 3 times, and the weight average molecular weight (Mw) is about 4 times. Thus, it is found that by using 1-hydroxycyclohexyl phenyl ketone in combination, the termination reaction on the polymerization terminal is suppressed, and a higher molecular weight is achieved.

Further, it is found from Table 6 that as compared with a case where phenyl 1,4-dihydroxy-2-naphthoate was used alone, when 1-hydroxycyclohexyl phenyl ketone was used in combination, phenyl 1,4-dihydroxy-2-naphthoate did not remain. It is considered that when phenyl 1,4-dihydroxy-2-naphthoate functions as the photoradical polymerization initiator, it is decomposed from a light-excited state to generate radical species, and it is estimated that by using 1-hydroxycyclohexyl phenyl ketone in combination, generation of radical species from phenyl 1,4-dihydroxy-2-naphthoate is effectively conducted. And further, problems of migration of the initiator and the sensitizer remaining in the cured product, after curing, occur practically, however, by using 1-hydroxycyclohexyl phenyl ketone in combination, no phenyl 1,4-dihydroxy-2-naphthoate remains, and thus the problems can be solved, and coloring by visible light absorption caused by remaining can be reduced. Further, by the photobleaching effect such that phenyl 1,4-dihydroxy-2-naphthoate is photolyzed to bring about initiation and sensitization, curing at deep portion will be possible.

### Example 19

In the same manner as in Example 15 except that 2-hydroxy-1-{[4-(2-hydroxy-2-methylpropionyl)benzyl]phenyl}-2-methylpropan-1-one was used instead of 1-hydroxycyclohexyl phenyl ketone as the alkylphenone type photoradical polymerization initiator, a photoradical polymerizable composition was prepared, which was irradiated with ultraviolet rays in the same manner, changes of the complex viscosity of the photoradical polymerizable composition were measured by the photo-rheometer, and the time (second) at which the complex viscosity reached 6,000 Pas was taken as the curing time and is shown in Table 7.

### Example 20

In the same manner as in Example 15 except that 2-hydroxy-2-methyl-1-phenylpropan-1-one was used instead of 1-hydroxycyclohexyl phenyl ketone as the alkylphenone type photoradical polymerization initiator, a photoradical polymerizable composition was prepared, which was irradiated with ultraviolet rays in the same manner, changes of the complex viscosity of the photoradical polymerizable composition were measured by the photo-rheometer, and the time (second) at which the complex viscosity reached 6,000 Pas was taken as the curing time and is shown in Table 7.

### Example 21

In the same manner as in Example 15 except that 2,2-dimethoxy-1,2-diphenylethan-1-one was used instead of 1-hydroxycyclohexyl phenyl ketone as the alkylphenone type photoradical polymerization initiator, a photoradical polymerizable composition was prepared, which was irradiated with ultraviolet rays in the same manner, changes of the complex viscosity of the photoradical polymerizable composition were measured by the photo-rheometer, and the time (second) at which the complex viscosity reached 6,000 Pas was taken as the curing time and is shown in Table 7.

### Comparative Example 11

In the same manner as in Example 19 except that phenyl 1,4-dihydroxy-2-naphthoate as the photoradical polymerization initiator was not added, a photoradical polymerizable composition was prepared, which was irradiated with ultraviolet rays in the same manner, changes of the complex viscosity of the photoradical polymerizable composition were measured by the photo-rheometer, and the time (second) at which the complex viscosity reached 6,000 Pas was taken as the curing time and is shown in Table 7.

### Comparative Example 12

In the same manner as in Example 20 except that phenyl 1,4-dihydroxy-2-naphthoate as the photoradical polymerization initiator was not added, a photoradical polymerizable composition was prepared, which was irradiated with ultraviolet rays in the same manner, changes of the complex viscosity of the photoradical polymerizable composition were measured by the photo-rheometer, and the time (second) at which the complex viscosity reached 6,000 Pas was taken as the curing time and is shown in Table 7.

### Comparative Example 13

In the same manner as in Example 21 except that phenyl 1,4-dihydroxy-2-naphthoate as the photoradical polymerization initiator was not added, a photoradical polymerizable composition was prepared, which was irradiated with ultraviolet rays in the same manner, changes of the complex viscosity of the photoradical polymerizable composition were measured by the photo-rheometer, and the time (second) at which the complex viscosity reached 6,000 Pas was taken as the curing time and is shown in Table 7.

The results in Examples 15, 19 to 21 and Comparative Examples 9 and 11 to 13 are shown in Table 7.

TABLE 7

| | Radical polymerizable | | | | | | |
|---|---|---|---|---|---|---|---|
| | compound | | Photoradical polymerization initiator | | | | |
| | | Amount | | Amount | | Amount | |
| | | used | | used | | used | |
| | | (parts | | (parts | | (parts | Curing |
| | | by | | by | | by | time |
| | Compound | weight) | Compound | weight) | Compound | weight) | (sec) |
| Ex. 15 | Trimethylolpropane | 100 | Phenyl | 0.2 | 1-Hydroxycyclohexyl phenyl ketone | 3 | 12.0 |
| Ex. 19 | triacrylate | | 1,4-dihydroxy-2- | | 2-Hydroxy-1-{[4-(2-hydroxy-2- | | 7.9 |
| | | | naphthoate | | methylpropionyl)benzyl] | | |
| | | | | | phenyl}-2-methylpropan-1-one | | |
| Ex. 20 | | | | | 2-Hydroxy-2-methyl-1-phenylpropan-1-one | | 7.8 |
| Ex. 21 | | | | | 2,2-Diethoxy-1,2-diphenylethan-1-one | | 10.2 |

| | | | |
|---|---|---|---|
| Comp. | Nil | 1-Hydroxycyclohexyl phenyl ketone | 79.0 |
| Ex. 9 | | | |
| Comp. | | 2-Hydroxy-1-{[4-(2-hydroxy-2- | 229.0 |
| Ex. 11 | | methylpropionyl)benzyl] | |
| | | phenyl}-2-methylpropan-1-one | |
| Comp. | | 2-Hydroxy-2-methyl-1-phenylpropan-1-one | 135.0 |
| Ex. 12 | | | |
| Comp. | | 2,2-Diethoxy-1,2-diphenylethan-1-one | 13.5 |
| Ex. 13 | | | |

Examples 19 to 21 are conducted in the same manner as in Example 15 except that other alkylphenone type photoradical polymerization initiator was used instead of 1-hydroxycyclohexyl phenyl ketone as the alkylphenone type photoradical polymerization initiator. Comparative Examples 9 and 11 to 13 are examples conducted in the same manner using the alkylphenone type photoradical polymerization initiator alone without using phenyl 1,4-dihydroxy-2-naphthoate. It is found from Table 7 that phenyl 1,4-dihydroxy-2-naphthoate has an effect to remarkably shorten the curing time also in combination with various alkylphenone type photoradical polymerization initiators.

### Example 22

To 100 parts of trimethylolpropane triacrylate (manufactured by Tokyo Chemical Industry Co., Ltd.) as a radical polymerizable compound, 5 parts of methyl-2-benzoylbenzoate (methyl o-benzoylbenzoate, trade name: OMNIRAD OMBB) and 0.5 parts of phenyl 1,4-dihydroxy-2-naphthoate 0.05 as photoradical polymerization initiators were added and stirred for dissolution to obtain a liquid photoradical polymerizable composition. The photoradical polymerizable composition was subjected to Photo-DSC measurement in a stream of air, and the total heating value and the time until the heating peak was reached were obtained. The total heating value was 90 mJ/mg in 5 minutes from the start of light irradiation, and the time until the heating peak was reached was 0.860 seconds. The results are shown in Table 8.

### Example 23

In the same manner as in Example 22 except that 0.2 parts of phenyl 1,4-dihydroxy-2-naphthoate was used, a photoradical polymerizable composition was prepared, the photoradical polymerizable composition was subjected to Photo-DSC measurement in a stream of air, and the total heating value and the time until the heating peak was reached were obtained. The total heating value was 254 mJ/mg in 5 minutes from the start of light irradiation, and the time until the heating peak was reached was 0.735 seconds. The results are shown in Table 8.

### Example 24

In the same manner as in Example 22 except that benzophenone was used instead of methyl-2-benzoylbenzoate as the photoradical polymerization initiator, a photoradical polymerizable composition was prepared, the photoradical polymerizable composition was subjected to Photo-DSC measurement in a stream of air, and the total heating value and the time until the heating peak was reached were obtained. The total heating value was 75.5 mJ/mg in 5 minutes from the start of light irradiation, and the time until the heating peak was reached was 0.875 seconds. The results are shown in Table 8.

### Example 25

In the same manner as in Example 24 except that 0.2 parts of phenyl 1,4-dihydroxy-2-naphthoate was used, a photoradical polymerizable composition was prepared, the photoradical polymerizable composition was subjected to Photo-DSC measurement in a stream of air, and the total heating value and the time until the heating peak was reached were obtained. The total heating value was 248 mJ/mg in 5 minutes from the start of light irradiation, and the time until the heating peak was reached was 0.726 seconds. The results are shown in Table 8.

### Example 26

In the same manner as in Example 22 except that 4-phenylbenzophenone (trade name: OMNIRAD 4PBZ) was used instead of methyl-2-benzoylbenzoate as a photoradical polymerization initiator, a photoradical polymerizable composition was prepared, the photoradical polymerizable composition was subjected to Photo-DSC measurement in a stream of air, and the total heating value and the time until the heating peak was reached were obtained. The total heating value was 101 mJ/mg in 5 minutes from the start of light irradiation, and the time until the heating peak was reached was 0.895 seconds. The results are shown in Table 8.

### Example 27

In the same manner as in Example 26 except that 0.2 parts of phenyl 1,4-dihydroxy-2-naphthoate was used, a photoradical polymerizable composition was prepared, the photoradical polymerizable composition was subjected to Photo-DSC measurement in a stream of air, and the total heating value and the time until the heating peak was reached were obtained. The total heating value was 241 mJ/mg in 5 minutes from the start of light irradiation, and the time until the heating peak was reached was 0.753 seconds. The results are shown in Table 8.

### Example 28

In the same manner as in Example 22 except that 1,4-dihydroxy-2-naphthoic acid was used instead of phenyl 1,4-dihydroxy-2-naphthoate as the photoradical initiator, a photoradical polymerizable composition was prepared, the photoradical polymerizable composition was subjected to Photo-DSC measurement in a stream of air, and the total heating value and the time until the heating peak was reached were obtained. The total heating value was 61.8 mJ/mg in 5 minutes from the start of light irradiation, and the time until the heating peak was reached was 0.985 seconds. The results are shown in Table 8.

### Comparative Example 14

In the same manner as in Example 22 except that 1,4-dihydroxy-2-naphthoic acid was used instead of phenyl 1,4-dihydroxy-2-naphthoate as the photoradical initiator, a photoradical polymerizable composition was prepared, the photoradical polymerizable composition was subjected to Photo-DSC measurement in a stream of air, and the total heating value and the time until the heating peak was reached were obtained. The total heating value was 1.1 mJ/mg in 5 minutes from the start of light irradiation. No heating peak was confirmed. The results are shown in Table 8.

### Comparative Example 15

In the same manner as in Example 22 except that phenyl 1,4-dihydroxy-2-naphthoate was not used, a photoradical polymerizable composition was prepared, the photoradical polymerizable composition was subjected to Photo-DSC measurement in a stream of air, and the total heating value was obtained. The total heating value was 0 mJ/mg in 5 minutes from the start of light irradiation. No heating peak was confirmed. The results are shown in Table 8.

### Comparative Example 16

In the same manner as in Example 24 except that phenyl 1,4-dihydroxy-2-naphthoate was not used, a photoradical polymerizable composition was prepared, the photoradical polymerizable composition was subjected to Photo-DSC measurement in a stream of air, and the total heating value was obtained. The total heating value was 1.1 mJ/mg in 5 minutes from the start of light irradiation. No heating peak was confirmed. The results are shown in Table 8.

### Comparative Example 17

In the same manner as in Example 26 except that phenyl 1,4-dihydroxy-2-naphthoate was not used, a photoradical polymerizable composition was prepared, the photoradical polymerizable composition was subjected to Photo-DSC measurement in a stream of air, and the total heating value and the time until the heating peak was reached were obtained. The total heating value was 69 mJ/mg in 5 minutes from the start of light irradiation, and the time until the heating peak was reached was 1.73 seconds. The results are shown in Table 8.

### Comparative Example 18

In the same manner as in Example 22 except that methyl-2-benzoylbenzoate was not used, a photoradical polymerizable composition was prepared, the photoradical polymerizable composition was subjected to Photo-DSC measurement in a stream of air, and the total heating value and the time until the heating peak was reached were obtained. The total heating value was 49.5 mJ/mg in 5 minutes from the start of light irradiation, and the time until the heating peak was reached was 1.105 seconds. The results are shown in Table 8.

### Comparative Example 19

In the same manner as in Example 23 except that methyl-2-benzoylbenzoate was not used, a photoradical polymerizable composition was prepared, the photoradical polymerizable composition was subjected to Photo-DSC measurement in a stream of air, and the total heating value and the time until the heating peak was reached were obtained. The total heating value was 209 mJ/mg in 5 minutes from the start of light irradiation, and the time until the heating peak was reached was 0.785 seconds. The results are shown in Table 8.

TABLE 8

| | Radical polymerizable | | | | | | | | |
|---|---|---|---|---|---|---|---|---|---|
| | compound | | Photoradical polymerization initiator | | | | | | |
| | | Amount | | Amount | | Amount | | | |
| | | used | | used | | used | Light | | |
| | | (parts | | (parts | | (parts | source | Time until | Heating |
| | | by | | by | | by | Wavelength | heating | value |
| | Compound | weight) | Compound | weight) | Compound | weight) | (nm) | peak (min) | (mJ/mg) |
| Ex. 22 | Trimethylolpropane | 100 | Phenyl | 0.05 | Methyl-2-benzoyl | 5 | 405 | 0.860 | 90.0 |
| Ex. 23 | triacrylate | | 1,4-dihydroxy-2- | 0.20 | benzoate | | | 0.735 | 254.0 |
| Ex. 24 | | | naphthoate | 0.05 | Benzophenone | | | 0.875 | 75.5 |
| Ex. 25 | | | | 0.20 | | | | 0.726 | 248.0 |
| Ex. 26 | | | | 0.05 | 4-Phenyl | | | 0.895 | 101.0 |
| Ex. 27 | | | | 0.20 | benzophenone | | | 0.753 | 241.0 |
| Ex. 28 | | | 1,4-Dihydroxy-2- | 0.05 | Methyl-2-benzoyl | | | 0.985 | 61.8 |
| | | | naphthoic acid | | benzoate | | | | |
| Comp. | | | 1,4-Dimethoxy-2- | 0.05 | Methyl-2-benzoyl | | | — | 1.1 |
| Ex. 14 | | | naphthoic acid | | benzoate | | | | |

| | | | | |
|---|---|---|---|---|
| Comp. | Nil | Methyl-2-benzoyl | — | 0.0 |
| Ex. 15 | | benzoate | | |
| Comp. | | Benzophenone | — | 1.1 |
| Ex. 16 | | | | |
| Comp. | | 4-Phenyl | 1.730 | 69.0 |
| Ex. 17 | | benzophenone | | |

| | | | | | |
|---|---|---|---|---|---|
| Comp. | Phenyl | 0.05 | Nil | 1.105 | 49.8 |
| Ex. 18 | naphthoate | | | | |
| Comp. | 1,4-dihydroxy-2- | 0.20 | | 0.785 | 209.0 |
| Ex. 19 | | | | | |

Examples 22 and 23 are examples in which as the photoradical polymerization initiators, phenyl 1,4-dihydroxy-2-naphthoate and methyl-2-benzoylbenzoate (methyl o-benzoylbenzoate, trade name: OMNIRAD OMBB) which is a general-purpose photoradical polymerization initiator were used in combination. Example 28 is an example in which 1,4-dihydroxy-2-naphthoic acid was used. Examples 24 and 25 are examples in which as the photoradical polymerization initiators, phenyl 1,4-dihydroxy-2-naphthoate and benzophenone which is a general-purpose photoradical polymerization initiator were used in combination, and Examples 26 and 27 are examples in which as the photoradical polymerization initiators, phenyl 1,4-dihydroxy-2-naphthoate and 4-phenylbenzophenone which is a general-purpose photoradical polymerization initiator were used in combination. It is found from comparison with Comparative Examples 15 to 17 that when 1,4-dihydroxy-2-naphthoic acid compound was used in combination, the heating value increased, and the time until the heating peak was reached was shortened. It is found from Comparative Examples 15 and 16 that methyl-2-benzoylbenzoate and benzophenone which are benzophenone type photoradical polymerization initiators have substantially no function as a polymerization initiator at a wavelength of 405 nm. Whereas use of the benzophenone type photoradical polymerization initiator, and phenyl 1,4-dihydroxy-2-naphthoate or 1,4-dihydroxy-2-naphthoic acid, in combination, accelerates radical polymerization.

On the other hand, it is found from Comparative Example 14 that with 1,4-dimethoxy-2-naphthoic acid having a structure analogous to phenyl 1,4-dihydroxy-2-naphthoate or 1,4-dihydroxy-2-naphthoic acid, substantially no heating was confirmed, and the composition was not cured. Thus, it is found that the 1,4-dihydroxy structure is important to achieve a synergistic effect by use of the benzophenone type photoradical polymerization initiator in combination.

### Example 29

To 100 parts of trimethylolpropane triacrylate (manufactured by Tokyo Chemical Industry Co., Ltd.) as a radical polymerizable compound, 3 parts of OMNIRAD TPO (2,4,6-trimethylbenzoyl-diphenylphosphine oxide) and 0.5 parts of phenyl 1,4-dihydroxy-2-naphthoate as photoradical polymerization initiators were added to prepare a radical polymerizable composition. 1 mg of the radical polymerizable composition was accurately weighed in an aluminum pan for measurement and set to a DSC measurement portion, and an optical DSC unit was attached. The sample was irradiated with light at 405 nm (UV-LED) for 5 minutes in an air atmosphere, and the degree of conversion was measured. The results are shown in Table 9.

Photo-DSC measurement was conducted as follows. As the DSC measurement apparatus, XDSC-7000 manufactured by Hitachi High-Tech Science Corporation was used, to which a unit for Photo-DSC measurement was attached so that DSC measurement could be conducted while the sample was irradiated with light.

As a light source for light irradiation for polymerization reaction, 405 nm LED lighting boxy (LLBK1) manufactured by AITEC SYSTEM Co., Ltd. was used. The illuminance was adjusted to 50 mW/cm². Light from the light source was led to the upper part of the sample by glass fibers, and controlled so that the sample was irradiated with light 30 seconds after the start of DSC measurement.

Photo-DSC measurement was conducted as follows. About 1 mg of the sample was accurately weighed in an aluminum pan for measurement and set to a DSC measurement portion, and an optical DSC unit was attached. Air was made to flow through the DSC measurement portion at a rate of 100 mL/min to conduct measurement in an air atmosphere. After the first measurement, the sample was left as it was and subjected to measurement again under the same conditions. The value obtained by subtracting the second measurement result from the first measurement result was taken as the measurement result of the sample. The results were compared based on the total heating value per 1 mg of the sample, unless otherwise specified. Since heating occurs as the polymerization reaction proceeds, the degree of progress of the polymerization reaction can be estimated by measuring the total heating value.

The degree of conversion was obtained by sealing trimethylolpropane triacrylate (TMPTA) (manufactured by Tokyo Chemical Industry Co., Ltd.) in an aluminum closed pan, conducting thermal analysis measurement by DSC while the temperature was increased from 30° C. to 300° C. at a rate of 5° C./min, the degree of conversion was calculated taking the total heating value of the obtained heating peak to be 100%.

### Example 30

In the same manner as in Example 29 except that 1,4-dihydroxy-2-naphthoic acid was used instead of phenyl 1,4-dihydroxy-2-naphthoate, a photoradical polymerizable composition was prepared and irradiated with light, and the degree of conversion was measured. The results are shown in Table 9.

### Comparative Example 20

In the same manner as in Example 29 except that phenyl 1,4-dihydroxy-2-naphthoate was not used, a photoradical polymerizable composition was prepared and irradiated with light, and the degree of conversion was measured. The results are shown in Table 9.

### Example 31

In the same manner as in Example 29 except that OMNIRAD 819 (bis(2,4,6-trimethylbenzoyl)phenylphosphine oxide) was used instead of OMNIRAD TPO, a photoradical polymerizable composition was prepared and irradiated with light, and the degree of conversion was measured. The results are shown in Table 9.

### Example 32

In the same manner as in Example 30 except that OMNIRAD 819 was used instead of OMNIRAD TPO, a photoradical polymerizable composition was prepared and irradiated with light, and the degree of conversion was measured. The results are shown in Table 9.

### Comparative Example 21

In the same manner as in Comparative Example 20 except that OMNIRAD 819 was used instead of OMNIRAD TPO, a photoradical polymerizable composition was prepared and irradiated with light, and the degree of conversion was measured. The results are shown in Table 9.

### Example 33

In the same manner as in Example 29 except that OMNIRAD TPO-L (ethyl (2,4,6-trimethylbenzoyl)phenylphosphinate) was used instead of OMNIRAD TPO, a photoradical polymerizable composition was prepared and irradiated with light, and the degree of conversion was measured. The results are shown in Table 9.

### Example 34

In the same manner as in Example 30 except that OMNIRAD TPO-L was used instead of OMNIRAD TPO, a photoradical polymerizable composition was prepared and irradiated with light, and the degree of conversion was measured. The results are shown in Table 9.

### Comparative Example 22

In the same manner as in Comparative Example 20 except that OMNIRAD TPO-L was used instead of OMNIRAD TPO, a photoradical polymerizable composition was prepared and irradiated with light, and the degree of conversion was measured. The results are shown in Table 9.

### Example 35

To 100 parts of trimethylolpropane triacrylate (manufactured by Tokyo Chemical Industry Co., Ltd.) as a radical polymerizable compound, 3 parts of Irgacure OXE01 (1,2-octanedione, 1-{4-(phenylthio)phenyl}-, 2-(o-benzoyloxime)) and 0.5 parts of phenyl 1,4-dihydroxy-2-naphthoate as photoradical polymerization initiators were added to prepare a radical polymerizable composition. 1 mg of the radical polymerizable composition was accurately weighed in an aluminum pan for measurement and set to a DSC measurement portion, and an optical DSC unit was attached. The sample was irradiated with light at 405 nm (UV-LED) for 5 minutes in an air atmosphere, and the degree of conversion was measured. The results are shown in Table 9.

### Example 36

In the same manner as in Example 35 except that 1,4-dihydroxy-2-naphthoic acid was used instead of phenyl 1,4-dihydroxy-2-naphthoate, a photoradical polymerizable composition was prepared and irradiated with light, and the degree of conversion was measured. The results are shown in Table 9.

### Comparative Example 23

In the same manner as in Example 35 except that phenyl 1,4-dihydroxy-2-naphthoate was not used, a photoradical polymerizable composition was prepared and irradiated with light, and the degree of conversion was measured. The results are shown in Table 9.

TABLE 9

| | Radical polymerizable | | | | | | | |
|---|---|---|---|---|---|---|---|---|
| | compound | | Photoradical polymerization initiator | | | | | |
| | | Amount | | Amount | | Amount | | |
| | | used | | used | | used | | |
| | | (parts | | (parts | | (parts | Light source | Degree of |
| | | by | | by | | by | Wavelength | conversion |
| | Compound | weight) | Compound | weight) | Compound | weight) | (nm) | (%) |
| Ex. 29 | Trimethylolpropane | 100 | Phenyl | 0.5 | OMNIRAD TPO | 3 | 405 | 88 |
| | triacrylate | | 1,4-dihydroxy-2-naphthoate | | | | | |
| Ex. 30 | | | 1,4-Dihydroxy-2-naphthoic | 0.5 | | | | 86 |
| | | | acid | | | | | |
| Comp. | | | Nil | | | | | 84 |
| Ex. 20 | | | | | | | | |
| Ex. 31 | Trimethylolpropane | 100 | Phenyl | 0.5 | OMNIRAD 819 | 3 | 405 | 97 |
| | triacrylate | | 1,4-dihydroxy-2-naphthoate | | | | | |
| Ex. 32 | | | 1,4-Dihydroxy-2-naphthoic | 0.5 | | | | 86 |
| | | | acid | | | | | |
| Comp. | | | Nil | | | | | 87 |
| Ex. 21 | | | | | | | | |
| Ex. 33 | Trimethylolpropane | 100 | Phenyl | 0.5 | OMNIRAD | 3 | 405 | 85 |
| | triacrylate | | 1,4-dihydroxy-2-naphthoate | | TPO-L | | | |
| Ex. 34 | | | 1,4-Dihydroxy-2-naphthoic | 0.5 | | | | 84 |
| | | | acid | | | | | |
| Comp. | | | Nil | | | | | 74 |
| Ex. 22 | | | | | | | | |
| Ex. 35 | Trimethylolpropane | 100 | Phenyl | 0.5 | Irgacure OXE01 | 3 | 405 | 74 |
| | triacrylate | | 1,4-dihydroxy-2-naphthoate | | | | | |
| Ex. 36 | | | 1,4-Dihydroxy-2-naphthoic | 0.5 | | | | 67 |
| | | | acid | | | | | |

| | | |
|---|---|---|
| Comp. | Nil | 66 |
| Ex. 23 | | |

OMNIRAD TPO: 2,4,6-trimethylbenzoyl-diphenylphosphine oxide
OMNIRAD 819: Bis(2,4,6-trimethylbenzoyl)phenylphosphine oxide
OMNIRAD TPO-L: Ethyl (2,4,6-trimethylbenzoyl)phenylphosphinate
Irgacure OXE01: 1,2-Octanedione, 1-[4-(phenylthiol)phenyl]-, 2-(o-benzoyloxime)

As evident from Comparative Examples 20 to 22, OMNIRAD TPO, 819, TPO-L as the acylphosphine oxide type photoradical polymerization initiators are active to light having a wavelength of 405 nm and provide a high degree of conversion. It is found that by adding the 1,4-dihydroxy-2-naphthoic acid compound as the photoradical polymerization initiator of the present invention, the degree of conversion is further increased. Particularly, the effect is remarkable when OMNIRAD TPO-L is used in combination with 1,4-dihydroxy-2-naphthoic acid compound. The effect is remarkable also when OMNIRAD 819 is used in combination with phenyl 1,4-dihydroxy-2-naphthoate.

Further, as evident from comparison between Examples 35 and 36, and Comparative Example 23, also when Irgacure OXE01 which is an oxime ester type photoradical polymerization initiator is used in combination with the 1,4-dihydroxy-2-naphthoic acid compound as the photoradical polymerization initiator of the present invention, the degree of conversion is further increased. This effect is remarkable when phenyl 1,4-dihydroxy-2-naphthoate is used. From the above results, the 1,4-dihydroxy-2-naphthoic acid compound as the photoradical polymerization initiator of the present invention can further increase the degree of conversion of the photoradical polymerizable composition by irradiation with light having a wavelength of 405 nm, when used in combination with the acylphosphine oxide type photoradical polymerization initiator or the oxime ester type photoradical polymerization initiator, which are active to the above wavelength.

### Example 43

To 100 parts of trimethylolpropane triacrylate as a radical polymerizable compound, 3 parts of Irgacure OXE02 and 0.5 parts of phenyl 1,4-dihydroxy-2-naphthoate as photoradical polymerization initiators were added and stirred for dissolution to obtain a liquid photoradical polymerizable composition. The photoradical polymerizable composition was applied on parallel plates in a thickness of 30 μm and irradiated with ultraviolet rays of 405 nm UV-LED manufactured by U-TECHNOLOGY Co., Ltd. at an illuminance of 50 mW/cm² in an air atmosphere, and changes of the complex viscosity of the photoradical polymerizable composition were measured by a photo-rheometer. The time (second) at which the complex viscosity reached 10,000 Pas was taken as the induction period (IP), and the results are shown in Table 10.

### Example 44

In the same manner as in Example 43 except that the thickness of the photoradical polymerizable composition was 50 μm, the composition was irradiated with light, and the time (second) at which the complex viscosity reached 10,000 Pas was measured. The results are shown in Table 10.

### Example 45

In the same manner as in Example 43 except that the thickness of the photoradical polymerizable composition was 100 μm, the composition was irradiated with light, and the time (second) at which the complex viscosity reached 10,000 Pas was measured. The results are shown in Table 10.

### Comparative Example 26

To 100 parts of trimethylolpropane triacrylate as a radical polymerizable compound, 3 parts of Irgacure OXE02 as a photoradical polymerization initiator was added and stirred for dissolution to obtain a liquid photoradical polymerizable composition. The photoradical polymerizable composition was applied on parallel plates in a thickness of 30 μm and irradiated with ultraviolet rays of 405 nm UV-LED manufactured by U-TECHNOLOGY Co., Ltd. at an illuminance of 50 mW/cm² in an air atmosphere, and changes of the complex viscosity of the photoradical polymerizable composition were measured by a photo-rheometer. The time (second) at which the complex viscosity reached 10,000 Pas was taken as the induction period (IP), and the results are shown in Table 10.

### Comparative Example 27

In the same manner as in Comparative Example 26 except that the thickness of the photoradical polymerizable composition was 50 μm, the composition was irradiated with light, and the time (second) at which the complex viscosity reached 10,000 Pas was measured. The results are shown in Table 10.

### Comparative Example 28

In the same manner as in Comparative Example 26 except that the thickness of the photoradical polymerizable composition was 100 μm, the composition was irradiated with light, and the time (second) at which the complex viscosity reached 10,000 Pas was measured. The results are shown in Table 10.

TABLE 10

| | Radical polymerizable | | | | | | | | |
|---|---|---|---|---|---|---|---|---|---|
| | compound | | Photoradical polymerization initiator | | | | | | |
| | | Amount | | Amount | | Amount | | | |
| | | used | | used | | used | | Light | |
| | | (parts | | (parts | | (parts | Film | source | Induction |
| | | by | | by | | by | thickness | Wavelength | period |
| | Compound | weight) | Compound | weight) | Compound | weight) | (μm) | (nm) | (sec) |
| Ex. 43 | Trimethylolpropane | 100 | Phenyl | 0.05 | Irgacure | 3 | 30 | 405 | 9 |
| Ex. 44 | triacrylate | | 1,4-dihydroxy-2-naphthoate | | OXE02 | | 50 | | 11 |
| Ex. 45 | | | | | | | 100 | | 14 |

| | | | |
|---|---|---|---|
| Comp. | Nil | 30 | 23 |
| Ex. 26 | | | |
| Comp. | | 50 | 22 |
| Ex. 27 | | | |
| Comp. | | 100 | 23 |
| Ex. 28 | | | |

Irgacure OXE02: Ethanone, 1-[9-ethyl-6-(2-methylbenzoyl)-9-carbazol-3-yl]-, l-(O-acetyloxime)

It is found from comparison between Examples 43 to 45 and Comparative Examples 26 to 28 that by using phenyl 1,4-dihydroxy-2-naphthoate as the photoradical polymerization initiator of the present invention in combination with Irgacure OXE02 as the oxime ester type photoradical polymerization initiator, the induction period which is the period until polymerization starts, is shortened to half or less, at any film thickness of 30 μm, 50 μm or 100 μm.

### Example 37

To 50 parts of phenoxyethyl methacrylate (manufactured by Hitachi Chemical Co., Ltd., FA-310M) and 50 parts of EO-modified bisphenol A dimethacrylate (manufactured by Hitachi Chemical Co., Ltd., FA-321M) as radical polymerizable compounds, 2 parts of 2,2′-bis(4-chlorophenyl)-4,4′,5,5′-tetrakisphenyl)-1,2′-biimidazole (HABI) and 0.2 parts of phenyl 1,4-dihydroxy-2-naphthoate as photoradical polymerization initiators were added and stirred for dissolution to obtain a liquid photoradical polymerizable composition. The photoradical polymerizable composition was applied between parallel plates so that the film thickness would be 10 μm to a photo-rheometer MCR102 (manufactured by Anton Paar) having a LED-UV irradiation apparatus (LED manufactured by AITEC SYSTEM Co., Ltd.) attached, and irradiated with ultraviolet rays of 405 nm at an illuminance of 200 mW/cm², for 300 seconds from 30 seconds after the start of measurement, and changes of the complex viscosity of the photoradical polymerizable composition were measured. The time (second) at which the complex viscosity reached 10,000 Pas from the start of light irradiation was taken as the curing time and shown in Table 11.

### Example 38

In the same manner as in Example 37 except that 1,4-dihydroxy-2-naphthoic acid was used instead of phenyl 1,4-dihydroxy-2-naphthoate, a photoradical polymerizable composition was prepared and irradiated with light, and the degree of conversion was measured. The results are shown in Table 11.

### Comparative Example 24

In the same manner as in Example 37 except that phenyl 1,4-dihydroxy-2-naphthoate was not used, a photoradical polymerizable composition was prepared and irradiated with light, and the degree of conversion was measured. The results are shown in Table 11.

### Example 39

To 50 parts of phenoxyethyl methacrylate (manufactured by Hitachi Chemical Co., Ltd., FA-310M) and 50 parts of EO-modified bisphenol A dimethacrylate (manufactured by Hitachi Chemical Co., Ltd., FA-321M) as radical polymerizable compounds, 2 parts of 2,2′-bis(4-chlorophenyl)-4,4′,5,5′-tetrakisphenyl)-1,2′-biimidazole (HABI) and 0.2 parts of phenyl 1,4-dihydroxy-2-naphthoate as photoradical polymerization initiators, and 0.2 parts of Leuco Crystal Violet (LCV) as a reducing agent were added and stirred for dissolution to obtain a liquid photoradical polymerizable composition. The photoradical polymerizable composition was applied between parallel plates so that the film thickness would be 10 μm to a photo-rheometer MCR102 (manufactured by Anton Paar) having a UV irradiation apparatus (manufactured by HAMAMATSU PHOTONICS K.K., LIGHTNINGCURE) attached, and irradiated with ultraviolet rays at an illuminance of 200 mW/cm² through a 405 nm band-pass filter for 300 seconds from 30 seconds after the start of measurement, and changes of the complex viscosity of the photoradical polymerizable composition were measured. The time (second) at which the complex viscosity reached 10,000 Pas from the start of light irradiation was taken as the curing time and shown in Table 11.

### Example 40

In the same manner as in Example 39 except that 1,4-dihydroxy-2-naphthoic acid was used instead of phenyl 1,4-dihydroxy-2-naphthoate, a photoradical polymerizable composition was prepared and irradiated with light, and the degree of conversion was measured. The results are shown in Table 11.

### Comparative Example 25

In the same manner as in Example 39 except that phenyl 1,4-dihydroxy-2-naphthoate was not used, a photoradical polymerizable composition was prepared and irradiated with light, and the degree of conversion was measured. The results are shown in Table 11.

### Example 41

To 50 parts of phenoxyethyl methacrylate (manufactured by Hitachi Chemical Co., Ltd., FA-310M) and 50 parts of EO-modified bisphenol A dimethacrylate (manufactured by Hitachi Chemical Co., Ltd., FA-321M) as radical polymerizable compounds, 2 parts of 2,2′-bis(4-chlorophenyl)-4,4′,5,5′-tetrakisphenyl)-1,2′-biimidazole (HABI), 0.2 parts of phenyl 1,4-dihydroxy-2-naphthoate and 0.2 parts of 1,4-dihydroxy-2-naphthoic acid as photoradical polymerization initiators were added and stirred for dissolution to obtain a liquid photoradical polymerizable composition. The photoradical polymerizable composition was applied between parallel plates so that the film thickness would be 10 μm to a photo-rheometer MCR102 (manufactured by Anton Paar) having a UV irradiation apparatus (manufactured by HAMAMATSU PHOTONICS K.K., LIGHTNINGCURE) attached, and irradiated with ultraviolet rays at an illuminance of 200 mW/cm² through a 405 nm band-pass filter, for 300 seconds from 30 seconds after the start of measurement, and changes of the complex viscosity of the photoradical polymerizable composition were measured. The time (second) at which the complex viscosity reached 10,000 Pas from the start of light irradiation was taken as the curing time and shown in Table 11.

### Example 42

In the same manner as in Example 41 except that 0.4 parts of 1,4-dihydroxy-2-naphthoic acid was used instead of 0.2 parts of phenyl 1,4-dihydroxy-2-naphthoate and 0.2 parts of 1,4-dihydroxy-2-naphthoic acid, a photoradical polymerizable composition was prepared and irradiated with light, and the degree of conversion was measured. The results are shown in Table 11.

TABLE 11

| | | Photoradical polymerization initiator | | | | Reducing agent | | | |
|---|---|---|---|---|---|---|---|---|---|
| | Radical | | Amount | | Amount | | Amount | | |
| | polymerizable | | used | | used | | used | Light | |
| | compound | | (parts | | (parts | | (parts | source | Curing |
| | (parts by | | by | | by | | by | Wavelength | time |
| | weight) | Compound | weight) | Compound | weight) | Compound | weight) | (nm) | (sec) |
| Ex. 37 | Phenoxyethyl | Phenyl | 0.2 | HABI | 2 | Nil | | 405 | 1760 |
| | methacrylate | 1,4-dihydroxy-2-naphthoate | | | | | | | |
| Ex. 38 | (50 parts) | 1,4-Dihydroxy-2-naphthoic | | | | | | | 610 |
| | EO modified | acid | | | | | | | |
| Comp. | bisphenol A | Nil | | | | | | | 4410 |
| Ex. 24 | dimethacrylate | | | | | | | | |
| Ex. 39 | (50 parts) | Phenyl | 0.2 | | | Leuco Crystal | 0.2 | | 410 |
| | | 1,4-dihydroxy-2-naphthoate | | | | Violet | | | |
| Ex. 40 | | 1,4-Dihydroxy-2-naphthoic | | | | | | | 280 |
| | | acid | | | | | | | |
| Comp. | | Nil | | | | | | | 670 |
| Ex. 25 | | | | | | | | | |
| Ex. 41 | | Phenyl | 0.2 | | | 1,4-Dihydroxy-2- | 0.2 | | 380 |
| | | 1,4-dihydroxy-2-naphthoate | | | | naphthoic acid | | | |

| | | | | |
|---|---|---|---|---|
| Ex. 42 | 1,4-Dihydroxy-2-naphthoic | 0.4 | Nil | 300 |
| | acid | | | |

HABI: 2,2′-bis(4-chlorophenyl)-4,4′,5,5′-tetrakisphenyl)-1,2′-biimidazole

As evident from comparison between Examples 37 and 38, and Comparative Example 24, it is found that by using the 1,4-dihydroxy-2-naphthoic acid compound as the photoradical polymerization initiator of the present invention in combination with HABI as a photoradical polymerization initiator, the curing time was remarkably shortened. This effect of shortening the curing time can be confirmed also from comparison between Examples 39 and 40 and Comparative Example 25 in which Leuco Crystal Violet (LCV) as a reducing agent was added. Further, as evident from comparison between Example 39 and Example 41, it is found that in an example in which 1,4-dihydroxy-2-naphthoic acid was added instead of Leuco Crystal Violet (LCV), the curing time was further shortened as compared with a composition containing Leuco Crystal Violet. Thus, it is found that as compared with HABI which is a photoradical polymerization initiator, the 1,4-dihydroxy-2-naphthoic acid compound as the photoradical polymerization initiator of the present invention has an effect to remarkably shorten the curing time, and in addition, without using Leuco Crystal Violet as a reducing agent usually used, the 1,4-dihydroxy-2-naphthoic acid compound has an effect of shortening the curing time more than when used.

### Comparative Example 29

To 50 parts of phenoxyethyl methacrylate (manufactured by Hitachi Chemical Co., Ltd., FA-310M) and 50 parts of EO-modified bisphenol A dimethacrylate (manufactured by Hitachi Chemical Co., Ltd., FA-321M) as radical polymerizable compounds, 2 parts of 2,2′-bis(4-chlorophenyl)-4,4′,5,5′-tetrakisphenyl)-1,2′-biimidazole (HABI) as a photoradical polymerization initiator and 0.2 parts of Leuco Crystal Violet were added and stirred for dissolution to obtain a liquid photoradical polymerizable composition. The photoradical polymerizable composition was stored in a transparent bottle, and the viscosity of the photoradical polymerizable composition was observed 17 hours later, 137 hours later and 233 hours later to evaluate the storage stability. The results are shown in Table 12.

### Comparative Example 30

In the same manner as in Comparative Example 29 except that the photoradical polymerizable composition was stored in a brown bottle, not in a transparent bottle, the storage stability was evaluated. The results are shown in Table 12.

### Example 46

To 50 parts of phenoxyethyl methacrylate (manufactured by Hitachi Chemical Co., Ltd., FA-310M) and 50 parts of EO-modified bisphenol A dimethacrylate (manufactured by Hitachi Chemical Co., Ltd., FA-321M) as radical polymerizable compounds, 2 parts of 2,2′-bis(4-chlorophenyl)-4,4′,5,5′-tetrakisphenyl)-1,2′-biimidazole (HABI) and 0.2 parts of 1,4-dihydroxy-2-naphthoic acid as photoradical polymerization initiators were added and stirred for dissolution to obtain a liquid photoradical polymerizable composition. The photoradical polymerizable composition was stored in a transparent bottle, and the viscosity of the photoradical polymerizable composition was observed 17 hours later, 137 hours later and 233 hours later to evaluate the storage stability. The results are shown in Table 12.

### Example 47

In the same manner as in Example 46 except that the photoradical polymerizable composition was stored in a brown bottle, not in a transparent bottle, the storage stability was evaluated. The results are shown in Table 12.

### Example 48

In the same manner as in Example 46 except that phenyl 1,4-dihydroxy-2-naphthoate was used instead of 1,4-dihydroxy-2-naphthoic acid, the storage stability was evaluated. The results are shown in Table 12.

### Example 49

In the same manner as in Example 48 except that the photoradical polymerizable composition was stored in a brown bottle, not in a transparent bottle, the storage stability was evaluated. The results are shown in Table 12.

TABLE 12

| | | Photoradical polymerization initiator or reducing agent | | | | | | | |
|---|---|---|---|---|---|---|---|---|---|
| | Radical | | Amount | | Amount | | Storage stability | | |
| | polymerizable | | used | | used | | (change of state) | | |
| | compound | | (parts | | (parts | | 17 | 137 | 233 |
| | (parts by | | by | | by | Storage | hours | hours | hours |
| | weight) | Compound | weight) | Compound | weight) | bottle | later | later | later |
| Ex. 46 | Phenoxyethyl | 1,4-Dihydroxy-2-naphthoic | 0.2 | HABI | 2 | Transparent | No | No | No |
| | methacrylate | acid | | | | | change | change | change |
| Ex. 47 | (50 parts) | | | | | Brown | No | No | No |
| | EO modified | | | | | | change | change | change |
| Ex. 48 | bisphenol A | Phenyl | 0.2 | | | Transparent | No | No | No |
| | dimethacrylate | 1,4-dihydroxy-2-naphthoate | | | | | change | change | change |
| Ex. 49 | (50 parts) | | | | | Brown | No | No | No |
| | | | | | | | change | change | change |
| Comp. | | Leuco Crystal Violet | 0.2 | | | Transparent | Cured | Cured | Cured |
| Ex. 29 | | | | | | | | | |
| Comp. | | | | | | Brown | No | Cured | Cured |
| Ex. 30 | | | | | | | change | | |

HABI: 2,2′-bis(4-chlorophenyl)-4,4,5,5′-tetrakisphenyl)-1,2′-biimidazole

As evident from comparison between Examples 46 to 49 and Comparative Examples 29 and 30, when the photoradical polymerizable composition contains HABI which is a photoradical polymerization initiator and contains Leuco Crystal Violet which is a reducing agent, it has poor storage stability and is cured within 137 hours even in a brown bottle. On the other hand, it is found that by adding the 1,4-dihydroxy-2-naphthoic acid compound of the present invention which is confirmed to have the same function as Leuco Crystal Violet instead, the storage stability is remarkably improved and is maintained even after 233 hours even in a transparent bottle.

### Experiment to Confirm Photobleaching Effect

### Example 50

To 100 parts of trimethylolpropane triacrylate as a radical polymerizable compound, 2 parts of phenyl 1,4-dihydroxy-2-naphthoate as a photoradical polymerization initiator and 1 part of MEGAFACE as a surfactant were added and stirred for dissolution to obtain a liquid photoradical polymerizable composition. The photoradical polymerizable composition was dropped on a 25 mm circular cover glass and formed into a 8 μm film by a spin coater. The sample was placed on a belt conveyor irradiation machine equipped with 405 nm UVLED, and while the sample was transferred at a rate of 1 m/min, it was irradiated with ultraviolet rays at an illuminance of 80 mW/cm². This operation was repeatedly carried out several times, and an absorption spectrum at each pass was measured by an ultraviolet visible absorption spectrometer UV-2600 manufactured by Shimadzu Corporation, and is shown in FIG. 2.

### Comparative Example 31

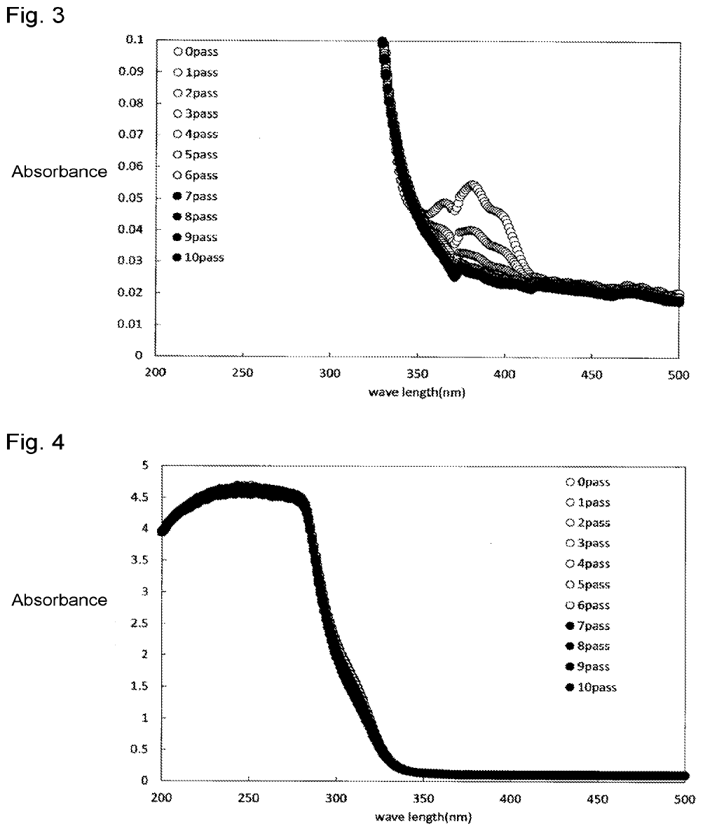

In the same manner as in Example 50 except that 2 parts of OMNIRAD TPO was used instead of 2 parts of phenyl 1,4-dihydroxy-2-naphthoate, a photoradical polymerizable composition was prepared, and in the same manner as in Example 50, an absorption spectrum was measured and shown in FIG. 3. The absorbance indicated by the vertical axis of the graph in FIG. 3 is at a scale one digit smaller than the other Figs. such as FIG. 2.

### Comparative Example 32

In the same manner as in Example 50 except that 2 parts of OMNIRAD 907 was used instead of 2 parts of phenyl 1,4-dihydroxy-2-naphthoate, a photoradical polymerizable composition was prepared, and in the same manner as in Example 50, an absorption spectrum was measured and shown in FIG. 4.

### Comparative Example 33

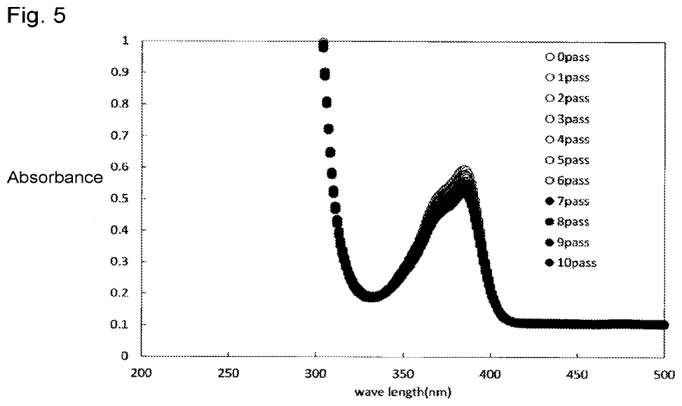

In the same manner as in Example 50 except that 2 parts of ITX was used instead of 2 parts of phenyl 1,4-dihydroxy-2-naphthoate, a photoradical polymerizable composition was prepared, and in the same manner as in Example 50, an absorption spectrum was measured and shown in FIG. 5.

As evident from FIG. 2, it is found that by conducting irradiation with 405 nm light repeatedly, ultraviolet absorption on the long wavelength side of phenyl 1,4-dihydroxy-2-naphthoate becomes weaker. This indicates a remarkable bleaching effect equal to or more than the bleaching effect of 2,4,6-trimethylbenzoyl-diphenylphosphine oxide (trade name: OMNIRAD TPO) known to have a remarkable photobleaching effect. Such bleaching effect is not observed at all or is observed only slightly in OMNIRAD 907 which is an existing well known photoradical polymerization sensitizer and ITX which is a thioxanthone type photoradical polymerization initiator, as shown in FIGS. 4 and 5. Thus, it is found that the 1,4-dihydroxy-2-naphthoic acid compound of the present invention is a very specific and highly practicable photoradical polymerization initiator having photobleaching effect.

### Storage Stability Test

### Example 51

To 100 parts of butyl acrylate (manufactured by Tokyo Chemical Industry Co., Ltd.) as a radical polymerizable compound, 0.2 parts of phenyl 1,4-dihydroxy-2-naphthoate, and further for accelerating the test, 2.0 parts of lauroyl peroxide as a heat radical polymerization initiator were added and stirred for dissolution to obtain a liquid radical polymerizable composition. The radical polymerizable composition was put in a glass bottle in an air atmosphere and sealed, and stored in dark place at room temperature. To evaluate the storage stability, the outer appearance and the viscosity of the radical polymerizable composition were observed with time. 75 Days later, no change was observed in the color and the viscosity of the radical polymerizable composition.

### Example 52

In the same manner as in Example 51 except that 1,4-dihydroxy-2-naphthoic acid was used instead of phenyl 1,4-dihydroxy-2-naphthoate, a radical polymerizable composition was prepared, and its storage stability was observed in the same manner. 75 Days later, no change was observed in the color and the viscosity of the radical polymerizable composition.

### Comparative Example 34

In the same manner as in Example 51 except no phenyl 1,4-dihydroxy-2-naphthoate was used, a radical polymerizable composition was prepared, and its storage stability was observed in the same manner. 75 Days later, the radical polymerizable composition was solidified.

As evident from Examples 51 and 52 and Comparative Example 34, it is found that the 1,4-dihydroxy-2-naphthoic acid compound of the present invention scavenges radicals generated in the radical polymerizable composition to prevent solidification of the radical polymerizable composition and prevent deterioration of the radical polymerizable composition over a period so long as 75 days, and thus has a function as a radical polymerization inhibitor in dark place.

### INDUSTRIAL APPLICABILITY

The 1,4-dihydroxy-2-naphthoic acid compound of the present invention is a practicable compound having a very special property, which not only has a capacity to function as a photoradical polymerization initiator and polymerize a radical polymerizable compound at a very high rate in photoradical polymerization reaction by irradiation with energy rays including light having a wavelength within a range of from 350 nm to 420 nm, but also functions as a radical polymerization inhibitor in dark place to prevent unintended radical polymerization and when irradiated with light having a wavelength within a range of from 350 nm to 420 nm, loses the radical polymerization inhibiting capacity and functions as a photoradical polymerization initiator, and further, has photobleaching effect. Further, the 1,4-dihydroxy-2-naphthoic acid compound is an environmentally friendly compound composed solely of carbon atoms, hydrogen atoms and oxygen atoms, and is industrially very useful as a highly safe photoradical polymerization initiator.

1. A photoradical polymerizable composition comprising a radical polymerizable compound and a photoradical polymerization initiator, wherein the photoradical polymerization initiator is a 1,4-dihydroxy-2-naphthoic acid compound represented by the following formula (1): 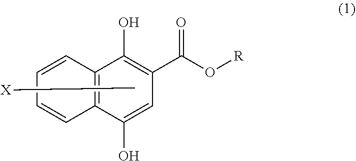
wherein R is a hydrogen atom, a C₁₋₁₀ alkyl group or a C₆₋₁₄ aryl group, and X is a hydrogen atom, a C₁₋₁₀ alkyl group, a C₆₋₁₄ aryl group, a hydroxy group, a C₁₋₁₀ alkoxy group or a C₆₋₁₄ aryloxy group,
provided that the alkyl group or the aryl group represented as R is optionally substituted by an alkoxy group, a hydroxy group or a (meth)acrylic group.

2. A photoradical polymerizable composition comprising
a radical polymerizable compound;
a first photoradical polymerization initiator comprising a 1,4-dihydroxy-2-naphthoic acid compound represented by the following formula (1): 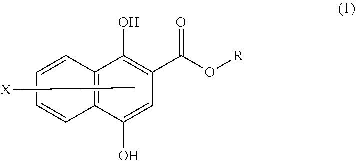
wherein R is hydrogen atom, a C₁₋₁₀ alkyl group or a C₆₋₁₄ aryl group, and X is a hydrogen atom, a C₁₋₁₀ alkyl group, a C₆₋₁₄ aryl group, a hydroxy group, a C₁₋₁₀ alkoxy group or a C₆₋₁₄ aryloxy group,
provided that the alkyl group or the aryl group represented as R is optionally substituted by an alkoxy group, a hydroxy group or a (meth)acrylic group; and
a second photoradical polymerization initiator, excluding the 1,4-dihydroxy-2-naphthoic acid compound, other than an onium salt.

3. The composition according to claim 2, wherein the second photoradical polymerization initiator, excluding the 1,4-dihydroxy-2-naphthoic acid compound, is an alkylphenone photoradical polymerization initiator, a benzophenone photoradical polymerization initiator or an anthraquinone photoradical polymerization initiator.

4. The composition according to claim 2, wherein the second photoradical polymerization initiator, excluding the 1,4-dihydroxy-2-naphthoic acid compound comprises an acylphosphine oxide photoradical polymerization initiator, an oxime ester photoradical polymerization initiator, an α-aminoacetophenone photoradical polymerization initiator or a thioxanthone photoradical polymerization initiator.

5. The composition according to claim 2, wherein the second photoradical polymerization initiator, excluding the 1,4-dihydroxy-2-naphthoic acid compound, is a biimidazole-type photoradical polymerization initiator.

6. The composition according to claim 2, wherein a blend ratio of the 1,4-dihydroxy-2-naphthoic acid compound to the second photoradical polymerization initiator excluding the 1,4-dihydroxy-2-naphthoic acid compound, is from 99:1 to 1:99 by weight ratio.

7. The composition according to claim 1, wherein the 1,4-dihydroxy-2-naphthoic acid compound is 1,4-dihydroxy-2-naphthoic acid.

8. The composition according to claim 1, wherein the 1,4-dihydroxy-2-naphthoic acid compound represented by the formula (1) is phenyl 1,4-dihydroxy-2-naphthoate.

9. The composition according to claim 1, further comprising a polymerizable resin.

10. A method for photopolymerizing the composition according to claim 1, comprising:
applying energy rays comprising light having a wavelength of 350 nm to 420 nm.
